(19) United States
(12) Patent Application Publication
(10) Pub. No.: US 2008/0275912 A1
(43) Pub. Date: Nov. 6, 2008

(54) Computer-Assisted Means for Providing Personalised Healthcare Products

(76) Inventors: Gareth Wyn Roberts, Great Shelford (GB); Rosalynn Dianne Gill-Garrison, Boulder, CO (US); Keith Grimaldi, London (GB)

Correspondence Address: NIXON & VANDERHYE, PC, 901 NORTH GLEBE ROAD, 11TH FLOOR, ARLINGTON, VA, 22203, US

(21) Appl. No.: 10/564,081

(22) PCT Filed: Jul. 9, 2004
(86) PCT No.: PCT/GB04/02979

§ 371 Date: Sep. 4, 2007

Related U.S. Application Data
(60) Provisional application No. 60/486,239, filed on Jul. 11, 2003.

(51) Int. Cl. G06F 17/00

(52) U.S. Cl. 707/104.1; 707/E17.001

(57) ABSTRACT

The present invention relates to a computer assisted method of providing a personalized assessment of supplement requirements for a human subject in which an individual's genotype is analysed for the presence of alleles at one or more genetic loci which may be associated with risk factors, and the alleles present compared to a first dataset comprising information correlating the presence of individual alleles at genetic loci with a lifestyle risk factor to provide a risk factor associated with the presence of particular alleles in order to generate a personalized assessment of nutritional and therapeutic supplement requirements, which may include a personalized supplementation formula.

### FIELD OF THE INVENTION

This invention relates to methods of enhancing or optimising the health and well-being of an individual in order to reduce disease susceptibility and tissue damage caused by environmental factors (e.g. nutrition status, extreme weather conditions, age, exposure to toxins etc). In particular, it relates to the provision of personalised healthcare products such as nutritional supplement and skincare formulations.

### BACKGROUND OF INVENTION

Many factors which contribute to health and well-being vary between populations and between individuals within populations and it is often impossible for an individual to derive specific advice appropriate to his or her own particular circumstances from general reports and research. Variations in the alleles of particular genes in certain populations and individuals lead to variations in the type and amount of nutritional supplements and therapeutic formulations required to optimise health, Minimise damage caused by environmental stresses and reduce susceptibility to illness. Nutritional supplement and therapeutic formulations and regimens most suitable for an individual may be different to those appropriate for the public as a whole.

### SUMMARY OF THE INVENTION

In order to enable an individual to protect and manage his or her own health and well-being, there is a need for personally-tailored recipes and formulations comprising specific supplements which are helpful in reducing the risk of disease and the effects of environmental stresses in that particular individual.

An aspect of the invention provides a computer-assisted method of providing a personalized supplement assessment for a human subject comprising:

(i) providing a first dataset on a data processing means, said first dataset comprising information correlating the presence of individual alleles at genetic loci with a lifestyle risk factor, wherein at least one allele of each genetic locus is known to be associated with increased or decreased well-being and/or disease susceptibility;

(ii) providing a second dataset on a data processing means, said second dataset comprising information matching each said risk factor with at least one supplement

(iii) inputting a third dataset identifying alleles at one or more of the genetic loci of said first dataset of said human subject;

(iv) determining the risk factors associated with said alleles of said human subject using said first dataset;

(v) determining at least one appropriate nutrient supplement recommendation based on each identified risk factor from step (iv) using said second dataset; and,

(vi) generating a personalized assessment of supplement requirements based on said recommendations.

A supplement is a compound or substance which is beneficial in maintaining or promoting health or well-being in an individual, for example by reducing or ameliorating the negative effects on the individual of lifestyle risk factors such as diet and environmental stresses. Supplements may be synthetic or natural substances or may be derived from natural substances, for example as a concentrate or extract. A supplement may be a nutrient or dietary supplement which provides an individual with a nutrient which is present in an insufficient quantity in the diet, or a therapeutic supplement, which has a direct therapeutic effect, for example at a site of topical administration. In particular, a skincare formulation may be topically applied to the skin. Examples of supplements suitable for use in accordance with the invention are provided below.

The personalised assessment may include recommended minimum and/or maximum amounts of each supplement identified in step (v) and/or a recipe for a personalised supplement formulation comprising the supplements identified in step (v). The assessment may be in the form of a report.

The report comprising the personalised supplement assessment may be delivered to the client by any suitable means, for example by letter, facsimile or electronic means, such as e-mail. Alternatively, the report may be posted on a secure Web-page of the service provider with access limited to the client by the use of a unique identifier notified to the client either by conventional or electronic mail. The report can therefore comprise one or more hyperlinks to other documents of the report provider's Web site or to other Web sites giving relevant information on the particular polymorphisms identified, disease prevention and/or supplement advice.

As such sites would be able to be updated and new hyperlinks added to the report after the report is initially delivered to the client, the information and advice would be able to be updated at any time, thereby allowing the client to access up-to-date yet personalised health and supplement advice over a prolonged period, without the need for requesting another report.

A method may comprise providing to said individual at least one supplement based on said recommendations. The supplements may be provided individually or in combination (i.e. as a single composition or formulation). A method may comprise formulating a personalized supplement formulation based on said recommendations. The formulation may comprise at least one supplement determined in step (v) above, preferably at least two, at least three or at least four such supplements. Most preferably, the formulation will comprise all the supplements determined in step (v) for the risk factors identified for the individual. Of course, the same supplement may be recommended on the basis of two or more different lifestyle risk factors, the supplement being beneficial for each of the risk factors. As described below, the one or more supplements may be formulated with a suitable carrier, excipient, diluent, filler, buffer, stabiliser, preservative and/or lubricant, according to standard techniques. A method may comprise assembling or producing a pack or kit comprising a personalised nutrient formulation comprising one or more supplements determined in step (v) above.

Alternatively, a method may comprise assembling or producing a pack or kit comprising separate preparations of the supplements determined in step (v) above. Each preparation may be provided in a separate container. The formulation, pack or kit may be provided and/or delivered to the individual.

By lifestyle risk factors, it is meant risk factors associated with dietary factors, exposure to environmental factors, such as smoking, environmental chemicals or sunlight. Supplement recommendations relate to substances which reduce or ameliorate the negative effects of lifestyle risk factors. Disease susceptibility should be interpreted to include susceptibility to conditions such as allergies.

Methods described herein provide for the generation of an individualised supplementation recipe based on the unique genetic profile of an individual and the susceptibility to disease and ill health associated with the profile. By individually assessing the genetic make-up of the client, specific risk factors can be identified and supplementation advice, for example nutritional supplementation advice, may be tailored to the individuals needs. In a preferred embodiment, the supplementation advice will include recommended daily quantities of selected supplement ingredients. (Note that an amount may be 0).

Information concerning the sex and health of the individual and/or of the individual's family may provide indications that a particular polymorphism or group of polymorphisms associated with a particular condition should be investigated. Such information may therefore be used in the selection of polymorphisms to be screened for in methods of the invention.

Such factors may also be used in the determination of appropriate nutritional or therapeutic (i.e. healthcare) supplementation recommendations in step (v) of the method. For example, supplement recommendations relating to reducing susceptibility to prostate cancer would not be given to women and supplement recommendations relating to susceptibility to ovarian cancer would not be given to men. Other factors, such as information regarding the age, alcohol consumption, and existing diet of the client may be incorporated into the determination of appropriate supplement recommendations in step (v).

Preferably, the method will involve assessing a variety of loci in order to give a broad view of susceptibility and possible means of minimising disease risk. Although individual polymorphisms may be considered biomarkers for individual cancer risk, the different biomarkers, when considered together, may also reveal a significant cancer risk. For example, the correlation between CYP1A1 activity and cancer susceptibility varies, dependent on the presence of specific types of CYP1A1 polymorphism as well as the presence of GSTM1 polymorphisms. An individual with an extremely active CYP1A1 gene, leading to high Phase I P450 activity in combination with a null GSTM1 genotype that lacks the detoxifying Phase II activities has a very high risk of developing cancer (Taningher, 1999).

The presence of a particular polymorphism may be indicative of increased susceptibilty to one disease while being indicative of decreased susceptibility to another disease. For example, one allele of the gene encoding epoxide hydrolase, which catalyses the conversion of toxic PAH metabolites formed by CYP1A1 and CYP1A2 into less toxic and more water-soluble trans-dihydrodiols, has recently been found to be associated with increased risk of aflatoxin-induced liver cancer, but also with decreased risk of ovarian cancer (Pluth, 2000; Taningher, 1999).

Preferred genes for which polymorphisms are identified include genes that encode Phase I metabolism enzymes responsible for detoxification of xenobiotics, genes that encode Phase II metabolism enzymes responsible for further detoxification and excretion of xenobiotics, in particular genes that encode enzymes responsible for conjugation reactions, genes that encode enzymes that combat oxidative stress, genes associated with micronutrient deficiency (for example, deficiency of folate, B12 or B6), genes that encode enzymes responsible for metabolism of alcohol, genes that encode enzymes involved in lipid and/or cholesterol metabolism, genes that encode enzymes involved in clotting, genes that encode trypsin inhibitors, genes that encode enzymes related to susceptibility to metal toxicity, genes which encode proteins required for normal cellular metabolism and growth and genes which encoded HLA Class 2 molecules. Other genes for which polymorphisms are identified may include genes involved in calcium metabolism and bone growth and maintenance and genes that encode proteins involved with inflammation processes.

For example, genes encoding the following enzymes may be tested: 5,10-methylenetetrahydrofolaite reductase (MTHFR), methionine synthase (MTR), methionine synthase reductase (MTRR), cystathione beta synthase (CBS), vitamin D receptor (VDR), collagen type I alpha (COL1A1), interleukin 6 (IL-6), tumour necrosis factor alpha (TNFα), angiotensin converting enzyme (ACE), peroxisome proliferators activated receptor (PPAR-gamma 2), manganese superoxide dismutase (SOD2), extracellular superoxide dismutase (SOD3), glutathione S-transferase M1 (GSTM1), glutathione S-transferase theta1 (GSTT1), glutathione S-transferase pi (GSTP1), apolipoprotein C-III (APOC3), cholesteryl ester transfer protein (CETP), lipoprotein lipase (LPL), endothelial nitric oxide synthase (eNOS), factor 5 (F5) and apolipoprotein E (ApoE4).

A computer-assisted method of providing a personalized supplement assessment for a human subject may comprise:

(i) providing a first dataset on a data processing means, said first dataset comprising information correlating the presence of individual alleles at genetic loci with a lifestyle risk factor; said genetic loci being in one or more categories selected from the group consisting of;

(a) phase I metabolism enzymes responsible for detoxification of xenobiotics,

(b) genes that encode Phase II metabolism enzymes responsible for further detoxification and excretion of xenobiotics,

(c) genes that encode enzymes that combat oxidative stress,

(d) genes associated with micronutrient deficiency,

(e) genes that encode enzymes responsible for metabolism of alcohol,

(f) genes that encode enzymes involved in lipid and/or cholesterol metabolism,

(g) genes that encode enzymes involved in clotting,

(h) genes that encode trypsin inhibitors,

(i) genes that encode enzymes related to susceptibility to metal toxicity,

(j) genes which encode proteins required for normal cellular metabolism and growth,

(k) genes which encoded HLA Class 2 molecules,

(l) genes that encode proteins involved with inflammation processes; and

(m) genes involved in calcium metabolism and bone growth and maintenance,

(ii) providing a second dataset on a data processing means, said second dataset comprising information matching each said risk factor with at least one supplement

(iii) inputting a third dataset identifying alleles at one or more of the genetic loci of said first dataset of said human subject;

(vi) determining the risk factors associated with said alleles of said human subject using said first dataset;

(vii) determining at least one appropriate nutrient supplement recommendation based on each identified risk factor from step (iv) using said second dataset; and,

(vi) generating a personalized assessment of supplement requirements based on said recommendations.

Examples of supplement recommendations for individuals with polymorphisms at particular genetic loci are shown in table 4.

The method of the invention may include the step of determining the presence of individual alleles at one or more genetic loci of the DNA in a DNA sample of the subject, and constructing the dataset used in step (iii) using results of that determination.

Techniques for determining the presence or absence of individual alleles are known to the skilled person. They may include techniques such as hybridization with allele-specific oligonucleotides (ASO) (Wallace, 1981; Ikuta, 1987; Nickerson, 1990, Varlaan-de Vries, 1986, Saiki, 1989 and Zhang, 1991) allele specific PCR (Newton 1989, Gibbs, 1989), solid-phase minisequencing (Syvanen, 1993), oligonucleotide ligation assay (OLA) (Wu, 1989, Barany, 1991; Abravaya, 1995), 5′ fluorogenic nuclease assay (Holland, 1991 & 1992, Lee, 1998) U.S. Pat. Nos. 4,683,202, 4,683,195, 5,723,591 and 5,801,155, or Restriction fragment length polymorphism (RFLP) (Donis-Keller, 1987).

In a preferred embodiment, the genetic loci are assessed via a specialised type of PCR used to detect polymorphisms, commonly referred to as the Taqman® assay, in which hybridisation of a probe comprising a fluorescent reporter molecule, a fluorescent quencher molecule and a minor groove binding chemical to a region of interest is detected by removal of quenching of the fluorescent molecule and detection of resultant fluorescence. Details are given below.

In another embodiment, the genetic loci are assessed via hybridisation with allele-specific oligonucleotides, the allele specific oligonucleotides being preferably arranged as an array of oligonucleotide spots stably associated with the surface of a solid support.

In order to assay the sample for the alleles to be identified, the fragments of DNA comprising the gene(s) of interest may be amplified to produce a sufficient amount of material to be tested.

A number of specific primer sets have been designed for amplification of gene regions of interest. Such primers may be used in pairs to isolate a particular region of interest in isolation and include primers having a sequence selected from SEQ ID NO: 86-99, 104-163. A primer pair may comprise primers having SEQ ID NO:n, where n is an even number from 86-98 or 104-162 in conjunction with a primer having SEQ ID NO:(n+1).

Primer sets may be used together with other primer sets to provide multiplexed amplification of a number of regions to allow determination of a number of polymorphisms from the same sample. For example, a primer set may comprise at least 5, more preferably 10, 15 primer pairs selected from SEQ ID NO: 86-121.

### BRIEF DESCRIPTION OF THE TABLES

Table 1 shows the primers and probes used to amplify genetic loci in methods of certain embodiments of the invention.

Table 2 shows examples of primers for identifying alleles at genes of interest.

Table 3 shows examples of probes for identifying alleles at genes of interest.

Table 4 shows examples of supplements suitable for individuals with the genetic polymorphisms shown.

Table 5 shows an example nutrient formulation for a carrier of MTHFR variant alleles

Table 6 shows examples of topical ingredients that may be included in skin creams for use by individuals with genetic polymorphism shown.

Table 7 shows examples of databases 1 and 2 which may be used in an embodiment of the present invention.

Table 8 is a flow chart illustrating an embodiment of the invention.

### DETAILED DESCRIPTION OF THE INVENTION

### Selection of Genetic Polymorphisms for Datasets

The correct selection of genetic polymorphisms is important to the provision of accurate and meaningful supplement recommendations. Although not limited to such classes of polymorphisms, in some embodiments of the present invention, the first dataset of the method of the invention may comprise information relating to two or more alleles of one or more genetic loci of genes selected from the group comprising:

(a) genes that encode enzymes responsible for detoxification of xenobiotics in Phase I metabolism;
(b) genes that encode enzymes responsible for conjugation reactions in Phase II metabolism;
(c) genes that encode enzymes that combat oxidative stress;
(d) genes associated with micronutrient deficiency;
(e) genes that encode enzymes responsible for metabolism of alcohol.
(f) genes that encode enzymes involved in lipid and/or cholesterol metabolism;
(g) genes that encode enzymes involved in clotting;
(h) genes that encode trypsin inhibitors;
(i) genes that encode enzymes related to susceptibility to metal toxicity;
(j) genes which encode proteins required for normal cellular metabolism and growth;
(k) genes which encoded HLA Class 2 molecules,
(l) genes that encode proteins involved with inflammation processes; and,
(m) genes involved in calcium metabolism and bone growth and maintenance.

In some preferred embodiments of the present invention, the first dataset of the method of the invention may comprise information relating to two or more alleles of one or more genetic loci of genes selected from the group consisting of a, b, c, d, e, f, g, i, j, l, and m (as shown above).

Alleles from one, two, three, four, five, six, seven, eight, nine or more genetic loci may be determined.

The dataset will preferably comprise information relating to two or more alleles of at least two genetic loci of genes selected from the group comprising categories a-m as described above, for example, a+b, a+c, a+d, a+e, a+f, a+g, a+h, a+i, a+j, a+k, a+l, a+m, b+c, b+d, b+e etc., c+d, c+e etc, d+e, d+f etc, e+f, e+g etc, f+g, f+h etc., g+h, g+i, g+j, g+k, g+l, g+m, h+i, h+j, h+k, h+l, h+m etc.

In other embodiments, the at least two genetic loci may be selected from the group comprising categories a-k as described above, or categories of a, b, c, d, e, f, g, i, j, l, and m.

Where the dataset comprises information relating to two or more alleles of at least two genetic loci, it is preferred that at least one of the genetic loci is of category d, due to the central role of micronutrients in the maintenance of proper cellular growth and DNA repair, and due to the association of micronutrient metabolism or utilisation disorders with several different types of diseases (Ames 1999; Perera, 2000; Potter, 2000). More preferably, the dataset will preferably comprise information relating to two or more alleles of at least three genetic loci selected from the group comprising categories a-k as described above. Where the dataset comprises information relating to alleles of at least three genetic loci, it is preferred that at least two of the genetic loci are of categories d and e. Information relating to polymorphisms present in both of these categories is particularly useful due to the effects of alcohol consumption and metabolism on the efficiency of enzymes related to micronutrient metabolism and utilisation (Ulrich, 1999). In a further preferred embodiment, where the dataset comprises information relating to alleles of at least three genetic loci, it is preferred that at least two of the genetic loci are of categories a and b due to the close interaction of Phase I and Phase II enzymes in the metabolism of xenobiotics. Even more preferably, the dataset will comprise information relating to two or more alleles of at least four genetic loci of genes selected from the group comprising categories a-m as defined above, for example, a+b+c+d, a+b+c+e, a+b+d+e, a+c+d+e, b+c+d+e etc. Where the dataset comprises information relating to alleles of at least four genetic loci, it is preferred that at least three of the genetic loci are of categories d and e and f. Information relating to polymorphisms present in these three categories is particularly useful due to the strong correlation of polymorphisms of these alleles with coronary artery disease due to the combined effects of altered micronutrient utilisation, affected adversely by alcohol metabolism, together with imbalances in fat and cholesterol metabolism. Further, where the dataset comprises information relating to alleles of at least five genetic loci, it is preferred that at least four of the genetic loci are of categories a, b, d and e. Information relating to polymorphisms present in these four categories is particularly useful due to the combined effects of micronutrients utilisation, alcohol metabolism, Phase 1 metabolism of xenobiotics and Phase II metabolism on the further metabolism and excretion of potentially harmful metabolites produced in the body (Taningher, 1999; Ulrich, 1999). Similarly, the dataset may comprise information relating to two or more alleles of at least five, for example a, b, d, e and f, six, seven, eight, nine, ten, eleven or twelve genetic loci of genes selected from the group comprising categories a-m as defined above (for example categories a-k or a-g, i, j, l, and m).

Preferably, the dataset will comprise information relating to two or more alleles of one or more genetic loci of genes selected from each member of the group comprising categories a-m as described above.

In a preferred embodiment, the first dataset comprises information relating to two or more alleles of the genetic loci of genes encoding each of the cytochrome P450 monooxygenase, N-acetyltransferase 1, N-acetyltransferase 2, glutathione-S-transferase, manganese superoxide dismutase, 5,10-methylenetetrahydrofolatereductase and alcohol dehydrogenase 2 enzymes. In a more preferred embodiment, the first dataset further comprises information relating to two or more alleles of the genetic loci of genes encoding one or more, preferably each of epoxide hydrolase (EH), NADPH-quinone reductase (NQ01), paraxonaoase (PON1), myeloperoxidase (MPO), alcohol dehydrogenase 1, alcohol dehydrogenase 3, cholesteryl ester transfer protein, apolipoprotein A IV, apolipoprotein E, apolipoprotein C III, angiotensin, factor VII, prothrombin 20210, β-fibrinogen, heme-oxygenase-1, α-antitrypsin, SPINK1, β-aminolevulinacid dehydratase, interleukin 1, interleukin 1, vitamin D receptor, B1 kinin receptor, cystathionine-beta-synthase, methionine synthase (B12 MS), 5-HT transporter, transforming growth factor beta 1 (TGFβ1), L-myc, HLA Class 2 molecules, T-lymphocyte associated antigen 4 (CTLA-4), interleukin 4, interleukin 3, interleukin 6, IgA, and/or galactose metabolism gene GALT.

In other preferred embodiments, the first dataset comprises information relating to two or more alleles of one or more genetic loci of genes selected from each member of the group comprising categories a, b, c, d, e, f, g, i, j, l and m as described above. For example, the first dataset may comprise information relating to two or more alleles of the genetic loci of genes encoding each of the 5,10-methylenetetrahydrofolate reductase (MTHFR), methionine synthase (MTR), methionine synthase reductase (MTRR), cystathione beta synthase (CBS), vitamin D receptor (VDR), collagen type 1 alpha (COL1A1), interleukin 6 (IL-6), tumour necrosis factor alpha (TNFα), angiotensin converting enzyme (ACE), peroxisome proliferators activated receptor (PPAR-gamma 2), manganese superoxide dismutase (SOD2), extracellular superoxide dismutase (SOD3), glutathione S-transferase M1 (GSTM1), glutathione S-transferase theta1 (GSTT1), glutathione S-transferase pi (GSTP1), apolipoprotein C-III (APOC3), cholesteryl ester transfer protein (CETP), lipoprotein lipase (LPL), endothelial nitric oxide synthase (eNOS), factor 5 (F5) and apolipoprotein E (ApoE4).

Genes that Encode Enzymes Responsible for (a) Detoxification of Xenobiotics in Phase I Metabolism; and (b) Conjugation Reactions in Phase II metabolism

Xenobiotics are potentially toxic compounds found in, for example, char-grilled red meat. Meat consumption is associated with increased risk of cancer, especially well-done meat cooked at high temperatures (Sinha, 1999). Cooking meat in this fashion leads to the production of heterocyclic amines (HCA), nitrosamines (NA), and polycyclic aromatic hydrocarbons (PAH), which have known carcinogenic activity in animals (Hirvonen, 1999; Layton, 1995).

Detoxification of xenobiotics occurs in two phases in humans (phase I and phase II):

Phase I metabolism involves the addition of an oxygen atom or a nitrogen atom to lipophilic (fat soluble) compounds, such as steroids, fatty acids, xenobiotics (from external sources like diet, smoke, etc.) so that they can be conjugated by the Phase II enzymes (thus made water-soluble) and excreted from the body (Hirvonen, 1999). Individuals with genetic polymorphisms correlated with cancer risk in these genes should also increase consumption of food products known to increase Phase II metabolism so the products of Phase I metabolism may be cleared more efficiently. These food products include cruciferous vegetables, such as Broccoli, Brussels sprouts, cauliflower, kale, kohlrabi, watercress, turnips and cabbage and allium vegetables such as onion, leeks and garlic. Concentrates of these products may also be consumed. Individuals may also avoid consumption of char-grilled foods, smoked fish, well-done red meat whether grilled or pan-fried (Sinha, 1999).

Supplements suitable for individuals with polymorphisms in the above genes include N-Acetyl-L-cysteine, Silymarin, Green tea leaf extract, Rosemary extract, cruciferous vegetable concentrate, and Schizandra berry.

Specific examples of genes of category a for which information relating to polymorphisms may be used in the present invention include genes encoding cytochrome P450 monooxygenase (CYP) e.g. CYP1A1, CYA1A2, CYP2C, CYP2D6, CYP2e1, CYP3A4, CYP11B2, genes encoding N-acetyltransferase 1 e.g. NAT1, genes encoding N-acetyltransferase 2 e.g. NAT2, genes encoding epoxide hydrolase (EH), genes encoding NADPH-quinone reductase (NQ01, genes encoding paraxonaoase (PON1) and genes encoding myeloperoxidase (MPO).

CYP is also referred to as cytochrome P450 monooxygenase (gene is called CYP, enzyme is called P450). P450 enzymes belong to a super-family with wide substrate activity that catalyses the insertion of an oxygen atom into a substrate. The reaction can convert a molecule (procarcinogen) into a DNA-reactive electrophilic carcinogen (Hirvonen, 1999; Smith, 1995). Polymorphisms in genes encoding cytochrome P450 (CYP family of genes) are associated with altered susceptibility to cancer, CAD and altered metabolism of various pharmaceutical agents (Poolsup, 2000; Miki, 1999; Cramer, 2000; Marchand, 1999; Sinha, 1997).

CYP1A1 codes for a P450 enzyme that metabolises polycyclic aromatic hydrocarbons (PAH). The CYP1A1 gene is polymorphic and is inducible by PAH, which means that expression of the enzyme is increased upon exposure to PAH (MacLeod, 1997). CYP1A1 is located on chromosome 15q22-q24 (Smith, 1995). This gene has been linked to colorectal, urinary bladder, breast, oral cavity, stomach, and lung cancers (Perera, 2000; Garte, 1998). The gene product, the P450 enzyme, is inducible by exposure to the agents that it metabolises, so the consumption of high levels of a potential source of carcinogens, such as well-done red meat, would increase the production of the enzyme and thus the creation of carcinogenic substances (Mooney, 1996; Perera, 2000; Alexandrie, A. K., 2000). Studies of polymorphisms of the CYP1A1 gene have revealed considerable differences in enzyme activity, with corresponding differences in cancer risk after exposure to known substrates of the enzyme (Alexandrie, 2000; Rojas, 2000; Garte, 2000). Both the Ile-Val polymorphism I, which comprises an A4889G substitution (i.e. the adenine residue at position 4889 of the 5′-3′ strand is substituted by a guanine residue) and the CYP1A1*C polymorphism, which comprises an T6235C substitution, are induced to a greater extent than the wild type gene after exposure to PAH, and have been associated with a significant increase in cancer risk (Taningher, 1999; Garte, 1998; Kawajiri, 1996; MacLeod, S., 1997; Smith, 1995). Approximately 10 percent of the Caucasian population carries polymorphisms linked to cancer risk, according to a recent American review paper (Shields, 2000). Polymorphisms in genes encoding CYP1A2, CYP2C, CYP2D6, CYP2E1, CYP3A4, CYP11B2 are associated with altered susceptibility to cancer and drug sensitivity. (Poolsup, 2000; Miki, 1999; Cramer, 2000; Marchand, 1999; Sinha, 1997). Supplements suitable for individuals with polymorphisms in these genes include Green tea leaf extract, lycopene, mixed carotenoids, vitamin D, Glutamine, Taurine, Milk Thistle, pyridoxine, vitamin C, selenium, phophatidyl choline and proanthocyanidinsand bioflavonoids.

NAT1 (N-acetyltransferase 1) and NAT2 (N-acetyltransferase 2) also activate PAH and heterocyclic amines (HAA). The enzymes catalyse N-acetylation, O-acetylation, and N,O-acetylation. The O-acetylation reaction is considered the most risky, with the potential for forming chemical carcinogens that can bind to DNA. The N-acetylation reaction can occur on a compound after a P450 has inserted an oxygen, thus increasing the water solubility of the compound so it may be excreted. Due to this activity, the NAT genes are often considered as both Phase I and Phase II type enzymes. The literature describing a cancer link focuses on the activation activity of the enzymes, so they will be listed in the Phase I section only. There are 3 separate N-acetyltransferase genes in humans, two are active genes: NAT1 and NAT2, and a pseudogene, NATP. Pseudogenes have the same sequence, but lack apparent function and promoter elements and are not expressed in cells (i.e. the gene is not transcribed into RNA then translated into amino acids to make a protein/enzyme) (Perera, 2000). NAT1 and NAT2 genes are located on chromosome 8 at 8p21.3-21.1, both genes are 870 bp long and both code for a protein 290 amino acids in length. The genes are highly polymorphic and epidemiological studies have sometimes given conflicting information regarding links with cancer. The genes show geographical and ethnic variation and the enzyme activity varies considerably within different tissues or organs. There are approximately 20 polymorphisms for NAT1 known to date, but the list below only includes the polymorphisms that have shown a link to cancer (Hein, 2000a). The list of nomenclature and polymorphisms known at present is kept at a web site: http://www.louisville.edu/medschool/pharmacology/NAT.html.

Many of the epidemiological studies of both NAT1 and NAT2 used phenotyping assays, which measured enzyme activity, and found fast and slow acetylator types, with the fast phenotype carrying an increased risk for cancer in the colon (Perera, 2000). However, later analysis of the results found that the fast/slow phenotype could vary considerably depending on the substrate chosen for acetylation (Hein, 2000a). Recent studies have used genetic sequence data to more precisely match acetylator activity and cancer risk with polymorphism (Hein, 2000b). Although the genes are the same size, they do act on different substrates. For example, caffeine is a substrate for NAT2 but not for NAT1.

NAT1 is expressed to a higher degree than NAT2 in the colon, so NAT1 may be associated with localised activity of activated HAA or PAH in the colon (Brockton, 2000; Perera, 2000). The polymorphism NAT1*10, which comprises T1088A and C1095A substitutions, and which has a fast phenotype, has been consistently linked with an increased risk of colon cancer and higher DNA adduct levels (i.e. DNA damage that can lead to cancer) in colon tissue (Perera, 2000; Ilett, 1987). The NAT1*I polymorphism has been linked to risk of breast cancer in women who smoke or consume well-done red meat (Zheng, 1999). However, the phenotype is not well understood, so this marker cannot be categorized as a fast or slow acetylator (Doll, 1997). Two alleles of the NAT1*I polymorphism are known: the NAT1*11A polymorphism, which comprises C(−344)T, A(−40)T, G445A, G459A, T640G, C1095A substitutions and a Δ9:1065-1090 deletion; and the NAT1*11B polymorphism, which comprises C(−344)T, A(−40)T, G445A, G459A, T640G substitutions and a Δ9:1065-1090 deletion. References to NAT1*I polymorphisms should be understood to include reference to NAT1*11A or NAT1*11B polymorphisms. Supplements suitable for individuals with polymorphisms in the above genes include Biopterin, L-tyrosine, pantothenic acid, Dandelion root, Turmeric, Vitamin B6, N-acetyl-glucosamine, co-enzyme Q10, nicotinic acid, choline and mixed carotenoids.

NAT1*14 on the other hand has little or no enzyme activity (Brockton, 2000) and has been associated with increased lung cancer risk (Bouchardy, C., 1998). Two alleles of the NAT1*14 polymorphism are known: the NAT1*14A polymorphism, which comprises G560A, T1088A and C1095A substitutions; and the NAT1*14B polymorphism, which comprises a G560A substitution. References to NAT1*14 polymorphisms should, except where the context dictates otherwise, be understood to include reference to NAT1*14A or NAT1*14B polymorphisms. The NAT1*14 polymorphism shares a restriction enzyme site with the NAT1*11polymorphism, and some of the conflicting results reported in the literature are believed to be due to the inability of the assay used (restriction fragment length polymorphism assay (RFLP)) to distinguish the polymorphisms (Hein, 2000a). The oligonucleotide array suitable for use in the present invention can distinguish all polymorphisms and therefore will be more precise than the RFLP procedure.

Supplements suitable for individuals with these polymorphisms include Biopterin, L-tyrosine, pantothenic acid, Dandelion root, Turmeric, Vitamin B6, N-acetyl-glucosamine, co-enzyme Q10, nicotinic acid, choline and mixed carotenoids.

NAT2 is expressed primarily in the liver, but has been linked with cancer incidence in other organs (Hein, 2000b). NAT2*5A, which comprises T481C and T341C substitutions, NAT2*6A, which comprises C282T and G590A substitutions, NAT2*7A, which comprises a G857A substitution, have reduced acetylation activity (Hein, 2000b) and have been linked to risk of bladder cancer (Taningher, 1999; Lee, 1998). NAT2*4, is considered the normal, or wild type, sequence. NAT2*4 has fast acetylator activity and has been linked to increased cancer risk in several studies (reviewed in Hein, 2000b; Gil, 1998), but especially in conjunction with the NAT1*10 polymorphism (Bell, 1995). NAT2 rapid/intermediate acetylators with at least one NAT2*4 allele have been linked to breast cancer in women who consumed well-done red meat (Dietz, 1999). Supplements suitable for individuals with these polymorphisms include Biopterin, L-tyrosine, pantothenic acid, Dandelion root, Turmeric, Vitamin B6, N-acetyl-glucosamine, co-enzyme Q10, nicotinic acid, choline and mixed carotenoids. Approximately 55% of the Caucasian population carry NAT1 polymorphisms linked to cancer. (Shields, 2000).

Polymorphisms in genes encoding epoxide hydrolase are associated with cancer and chronic obstructive pulmonary disease (Pluth, 200; Miki, 1999). Polymorphisms in genes encoding NADPH-quinone reductase are associated with altered susceptibility to cancer (Nakajima, 2000). Polymorphisms in genes encoding paraxonoase are associated with altered susceptibility to cancer and to CAD (MacKness, 2000). Polymorphisms in genes encoding myeloperoxidase are associated with altered susceptibility to CAD (Schabath, 2000). Supplements suitable for individuals with these polymorphisms include L-carnitine, Artichoke extract, Green tea leaf extract, Hawthorne extract, Garlic extract, Taurine, Dandelion root extract, Curcumin root extract, Glycine, Artichoke extract and Silymarin.

Specific examples of genes of category b for which information relating to polymorphisms may be used in the present invention include genes encoding glutathione-S-transferase e.g. GSTM1, GSTP1, GSTT1. Supplements suitable for individuals with low activity of one or more of these enzymes include N-Acetyl-L-cysteine, Silymarin, Green tea leaf extract, Rosemary extract, Cruciferous veg concentrate and Schizandra berry.

Glutathione-S-transferases catalyse the reaction of electrophilic compounds with glutathione so the compounds may be excreted from the body. The enzymes belong to a super-family with broad and overlapping substrate specificities. Glutathione-S-transferases provide a major pathway of protection against chemical toxins and carcinogens and are thought to have evolved as an adaptive response to environmental insult, thus accounting for their wide substrate specificity (Hirvonen, 1999). There are 4 family members: alpha, mu, theta, and pi, also designated as A, M, T and P. Polymorphisms have been identified in each family (Perera, 2000). Individuals with low glutathione-S-transferase activity should avoid meats cooked at higher temperatures as above, and increase fruit and vegetable consumption. Cruciferous vegetables such as broccoli and members of the allium family such as garlic and onion, for example, have been shown to be potent inducers of these enzymes, which would be expected to increase clearance of toxic substances from the body (Cotton, 2000; Giovannucci, 1999).

GSTmu, has 3 alleles: null, a, which is considered to be the wild type, and b, which comprises a C534G substitution, with no functional difference between the a and b alleles. The GSTmu sub-type has the highest activity of the 4 types and is predominately located in the liver (Hirvonen, 1999). Approximately half of the population has a complete deletion of this gene with a corresponding risk of lung, bladder, breast, liver, and oral cavity cancer (Shields, 2000; Perera, 2000). It has been estimated that 17% of all lung and bladder cancers may be attributable to GSTM1 null genotypes (Hirvonen, 1999). GSTM1 null genotype together with a highly active CYP1A1 polymorphism has been linked to a very high cancer risk in several studies (Rojas, 2000; Shields, 2000). The GSTM1 gene is located on chromosome 1p13.3 (Cotton, 2000).

GSTpi gene is located on chromosome 11q13. This sub-type is known to metabolise many carcinogenic compounds and is the most abundant sub-type in the lungs (Hirvonen, 1999). Two single nucleotide polymorphisms have been linked to cancer to date GSTP1*B, which comprises an A313G substitution, and GSTP1*C, which comprises a C341T substitution. The enzymes of these polymorphic genes have decreased activity compared to the wild type and a corresponding increased risk of bladder, testicular, larynx and lung cancer (Harries, 1997; Matthias, 1998; Ryberg, 1997).

GSTtheta gene is on chromosome 22q11.2 and is deleted in approximately 20% of the Caucasian population. The enzyme is found in a variety of tissues, including red blood cells, liver, and lung (Potter, 1999). The deletion is associated with an increased risk of lung, larynx and bladder cancers (Hirvonen, 1999). Links with GSTM1 null genotypes are currently being searched, as it is believed that individuals that have both GSTM1 and GSTT1 alleles deleted will have a greatly increased risk of developing cancer (Potter, 1999).

Genes that Code for Enzymes that Help Cells to Combat Oxidative Stress

Specific examples of genes of category c for which information relating to polymorphisms may be used in the present invention include genes encoding manganese superoxide dismutase (MnSOD or SOD2 gene) and extracellular superoxide dismutase (SOD3).

Manganese superoxide dismutase is an enzyme that destroys free radicals or a free-radical scavenger. The gene is located on chromosome 6q25.3, but the enzyme is found within the mitochondria of cells. There are 2 polymorphisms linked to cancer to date, an Ile 58Thr allele, which comprises an T175C substitution, and a Val(−9)Ala allele, which comprises a T(−28)C substitution. A study of premenopausal women found a four-fold increased risk of breast cancer in individuals with the Val (−9) Ala polymorphism and the highest risk within this group is found in women who consumed low amounts of fruits and vegetables (Ambrosone, 1999). This polymorphism occurs in the signal sequence of the amino acid chain. The signal sequence ensures transport of the enzyme into the mitochondria of the cell, and so the polymorphism is believed to reduce the amount of enzyme delivered to the mitochondria (Ambrosone, 1999). The mitochondria are commonly referred to as the workhorses of cells, where the energy-yielding reactions take place. This is the site of many oxidative reactions, so many free radicals are generated here. Individuals with low activity of this enzyme should be advised to take antioxidant supplements and increase consumption of fruits and vegetables (Giovannucci, 1999; Perera, 2000).

Supplements suitable for individuals with low MnSOD activity include Zinc, copper, manganese, N-Acetyl-L-cysteine, lutein, lycopene, Indole-3-Carbinol, Bilberry fruit extract, Alpha-lipoic acid, mixed cartenoids and taurine.

Genes Associated with Micronutrient Deficiency

Specific examples of genes of category d for which information relating to polymorphisms may be used in the present invention include the gene encoding 5,10-methylenetetrahydrofolatereductase (MTHFR) activity.

5,10-methylenetetrahydrofolate reductase is active in the folate-dependent methylation of DNA precursors. Low activity of this enzyme leads to an increase of uracil incorporation into DNA (instead of thymine) (Ames, 1999). The MTHFR gene is polymorphic and has been linked to colon cancer, adult acute lymphocytic leukaemia and infant leukaemia (Ames, 1999; Perera, 2000; Potter, 2000). Both the wt and polymorphic alleles have been linked to disease, each being dependent on levels of folate in the diet. Approximately 35% of the Caucasian population has genetic polymorphisms at this locus with corresponding risk of colon cancer (Shields, 2000). Polymorphisms at this locus include those with a C677T or A1298C substitution.

Supplements for individuals with low MTHFR activity may include some or all of the following ingredients: Riboflavin, niacin, vitamin B6, folate, vitamin B12 and L-serine. Other dietary recommendations for individuals lacking in MTHFR activity include increasing consumption of fruit and vegetables (Ames, 1999). Alcohol has a deleterious effect on folate metabolism, affecting individuals with the A1298C polymorphism most severely (Ulrich, 1999). These individuals may be advised to avoid alcohol.

Genes that Code for Enzymes Responsible for Metabolism of Alcohol

Specific examples of genes of category e for which information relating to polymorphisms may be used in the present invention include genes encoding alcohol dehydrogenase e.g. the ALDH2 gene, ALDH1 gene and ALDH3 gene.

Alcohol dehydrogenase 2 (ALDH2) is involved in the second step of ethanol utilisation. Reduced activity of this enzyme leads to accumulation of acetaldehyde, a potent DNA adduct former (Bosron, 1986). There has been one polymorphism identified to date, the ALDH2*2 polymorphism, which comprises a G1156A substitution, and which has links with oesophageal/throat cancer, stomach, lung, and colon cancer (IARC, 1998; Yokoyama, 1998). The advice to individuals with the polymorphism would be to avoid alcohol. Polymorphisms in ALDH1 and 3 are associated with increased susceptibility to cancers and Parkinson's disease. Supplements suitable for individuals with polymorphisms in these genes include Vitamins A, C, D & E, Thiamin, Riboflavin, Niacin, Vit B6, Folate, Vit B12, Biotin, Pantothenic Acid, Calcium, Iron, Iodine, Magnesium, Zinc, Selenium, Copper, Manganese, Chromium, Molybednium, Potassium, Boron, Vanadium, Quercetin dihydrate, N-Acetyl-L-cysteine, Lutein, Lycopene, Indole-3-Carbinol, Bilberry fruit extract, Alpha-lipoic acid, Mixed carotenoids, Taurine, Cat's claw bark extract, Green tea leaf extract, Forskolin, Ginkgo Biloba leaf extract, L-Serine and Garlic extract.

Genes that Encode Enzymes Involved in Lipid and/or Cholesterol Metabolism

Specific examples of genes of category f for which information relating to polymorphisms may be used in the present invention include genes encoding cholesteryl ester transfer protein e.g. the CETP gene, polymorphisms of which genes are associated with altered susceptibility to coronary artery disease (CAD) ((Raknew, 2000; Ordovas, 2000); genes encoding apolipoprotein A, IV (ApoA-IV), polymorphisms of which genes are associated with altered susceptibility to coronary artery disease (CAD) (Wallace, 2000; Heilbronn, 2000); apolipoprotein E(ApoE), polymorphisms of which genes are associated with altered susceptibility to CAD and Alzheimer's disease (Corbo, 1999; Bullido, 2000); or apolipoprotein C, III (ApoC-III), polymorphisms of which genes are associated with altered susceptibility to CAD, hypertension and insulin resistance (Salas, 1998). Supplements suitable for individuals with low CETP activity include Taurine, Dandelion root extract, Curcumin root extract, Glycine, Artichoke extract, Silymarin. Supplements suitable for individuals with low ApoC-III activity include L-carnitine, Artichoke extract, Green tea leaf extract, Hawthorne extract and Garlic extract.

Genes that Encode Enzymes Involved in Clotting Mechanisms

Specific examples of genes of category g for which information relating to polymorphisms may be used in the present invention include genes encoding angiotensin (AGT-1) and angiotensin converting enzyme (ACE), polymorphisms of which genes are associated with altered susceptibility to hypertension (Brand 2000; de Padua Mansur, 2000), factor V, factor VII, polymorphisms of which genes are associated with altered susceptibility to CAD (Donati, 2000; Di Castelnuovo, 2000); prothrombin 20210, polymorphisms of which genes are associated with altered susceptibility to venous thrombosis (Vicente, 1999); β-fibrinogen, polymorphisms of which genes are associated with altered susceptibility to CAD (Humphries, 1999); or heme-oxygenase-1, polymorphisms of which genes are associated with altered susceptibility to emphysema (Yamada, 2000). Supplements suitable for individuals with polymorphisms in these genes include Magnesium, Taurine, Hawthorne extract, Andrographis, Ginkgo Biloba, omega-6 or omega-3 fatty acids, calcium, vitamin K, vitamin D, vitamin E, red wine extract, flavonoids, phosphorous and garlic.

Genes that Encode Trypsin Inhibitors

Specific examples of genes of category h for which information relating to polymorphisms may be used in the present invention include genes encoding a-antitrypsin, polymorphisms of which genes are associated with altered susceptibility to chronic obstructive pulmonary disease (COPD) (Miki, 1999); or serine protease inhibitor, Kazal type i(SPINK), polymorphisms of which genes are associated with altered susceptibility to pancreatitis (Pfutzer, 2000). Supplements suitable for individuals with these polymorphisms include proteases, cellulases, β-glucanase, pentosanases, phytase, Pancreatin, Betaine Hydrochloride, Lipase, Ox Bile Extract, Bromelain, Papaya Enzymes and Pinapple Enzymes.

Genes that Encode Enzymes Related to Susceptibility to Metal Toxicity

Specific examples of genes of category i for which information relating to polymorphisms may be used in the present invention include genes encoding Δ-aminolevulinacid dehydratase, polymorphisms of which genes are associated with altered susceptibility to lead toxicity (Costa, 2000), the vitamin D receptor, polymorphisms of which genes are associated with altered susceptibility to osteoporosis, tuberculosis, Graves disease, COPD, and early periodontal disease (Ban, 2000; Wilkinson, 2000; Gelder, 2000; Miki, 1999; Hennig, 1999); cystathionine-beta-synthase, polymorphisms of which genes are associated with altered susceptibility to CAD (Tsai, 1999); methionine synthase (B12 MS) and methionine synthase reductase, polymorphisms of which genes are associated with altered susceptibility to CAD (Tsai, 1999); and transforming growth factor alpha (TGFα), polymorphisms of which genes are associated with altered susceptibility to CAD and cancers (Yokota, 2000).

Supplements suitable for individuals with polymorphisms in these genes include Glutathione, methionine, Cysteine, branched chain amino acids, Chlorella Pyrenoidosa, activated charcoal, cilantro and yellow dock, vitamin C, EDTA, Sodium alginate, Cilantro, melatonin, Magnesium malate, Selenium, Zinc, alpha lipoic acid and garlic.

Genes which Encode Proteins Required for Normal Cellular Metabolism and Growth

Specific examples of genes of category j for which information relating to polymorphisms may be used in the present invention include genes encoding the B1 kinin receptor (B1R), polymorphisms of which genes are associated with altered susceptibility to kidney disease (Zychma, 1999); cystathionine-beta-synthase, polymorphisms of which genes are associated with altered susceptibility to CAD (Tsai, 1999); methionine synthase (B12 MS), polymorphisms of which genes are associated with altered susceptibility to CAD (Tsai, 1999); the 5-HT transporter, polymorphisms of which genes are associated with altered susceptibility to neurological disorders, Alzheimer's disease, schizophrenia, other disorders of the serotonin pathway (Oliveira, 1999); tumour necrosis factor receptor 2 (TNFR2), polymorphisms of which genes are associated with altered susceptibility to CAD (Fernandez-Real, 2000); galactose metabolism gene GALT, polymorphisms of which genes are associated with altered susceptibility to ovarian cancer (Cramer, 2000); transforming growth factor beta 1 (TGFβ1), polymorphisms of which genes are associated with altered susceptibility to CAD and cancers (Yokota, 2000); and L-myc, polymorphisms of which genes are associated with altered susceptibility to CAD (especially in relation to tolerance to smoking) and cancers (Togo, 2000).

Supplements suitable for individuals with vitamin D receptor polymorphisms include Vitamin E, Calcium, Indole-3-Carbinol and Cruciferous veg concentrate.

Supplements suitable for individuals with polymorphisms in these genes include Riboflavin, niacin, vitamin B6, folate, vitamin B12, L-serine, Alpha-lipoic acid, Curcumin root extract, Cat's claw bark extract, Green tea leaf extract, Nettle leaf extract, Magnolia bark extract, Forskolin, Ginkgo Biloba leaf extract, L-carnitine, Artichoke extract, Hawthorne extract, Garlic extract, mixed carotenoids, co-enzyme Q10, vitamin D, vitamin C and vitamin E.

Genes which Encode HLA Class 2 Molecules and Proteins Associated with Immunological Susceptibility

Specific examples of genes of category k and 1 for which information relating to polymorphisms may be used in the present invention include genes encoding HLA Class 2 molecules, polymorphisms of which genes are associated with altered susceptibility to cervical cancer and human papilloma virus (HPV) infection (Maciag, 2000); T-lymphocyte associated antigen 4 (CTLA-4), polymorphisms of which genes are associated with altered susceptibility to liver disease (Argawal, 2000); interleukin 1 (IL-1), polymorphisms of which are associated with cardiovascular disease and periodontal disease (macaiag, 2000; Nakajima, 2000); TNF-A, polymorphisms of which genes are associated with altered susceptibility to osteoporosis (Roggia et al., 2001) and asthma (Thomas, 2000); IL-4, polymorphisms of which genes are associated with altered susceptibility to atopy and asthma (Rosa-Rosa, 1999); IL-3, polymorphisms of which genes are associated with altered susceptibility to atopy and asthma (Rosa-Rosa, 1999); IL-6, polymorphisms of which genes are associated with altered susceptibility to osteoporosis; and IgA, polymorphisms of which genes are associated with altered susceptibility to COPD (Miki, 1999). Supplements suitable for individuals with IL-6 polymorphisms include Vitamin D, Quercetin dihydrate, N-Acetyl-L-cysteine, Goldenseal root extract, Scutellaria baicalensis root extract, and Epimedium grandiflorum. Supplements suitable for individuals with polymorphisms in other genes include Vitamin D, Quercetin dihydrate, N-Acetyl-L-cysteine, Goldenseal root extract, Scutellaria baicalensis root extract, Epimedium grandiflorum, Vitamin E, Calcium, Indole-3-Carbinol, Cruciferous veg concentrate, Silymarin, Green tea leaf extract, Rosemary extract, N-Acetyl-L-cysteine, lutein, lycopene, Indole-3-Carbinol and Bilberry fruit extract.

### Genes Involved in Calcium Metabolism and Bone Growth and Maintenance

Specific examples of genes of category m for which information relating to polymorphisms may be used in the present invention include IL-6, polymorphisms of which genes are associated with altered susceptibility to osteoporosis.

### Detection of Polymorphisms

As described above, the method of the invention may include the step of analysing a DNA sample of a human subject in order to construct the dataset to be used in the method of the invention.

### Testing of Samples

### Collection of Tissue Samples

DNA for analysis using the method or arrays of the invention can be isolated from any suitable client or patient cell sample. For convenience, it is preferred that the DNA is isolated from cheek (buccal) cells. This enables easy and painless collection of cells by the client, with the convenience of being able to post the sample to the provider of the genetic test without the problems associated with posting a liquid sample.

Cells may be isolated from the inside of the mouth using a disposable scraping device with a plastic or paper matrix “brush”, for example, the C.E.P. Swab™ (Life Technologies Ltd., UK). Cells are deposited onto the matrix upon gentle abrasion of the inner cheek, resulting in the collection of approximately 2000 cells (Aron, 1994). The paper brush can then be left to dry completely, ejected from the handle placed into a microcentrifuge tube and posted by the client or patient to the provider of the genetic test.

Isolation of DNA from Samples

DNA from the cell samples can be isolated using conventional procedures. For example DNA may be immobilised onto filters, column matrices, or magnetic beads. Numerous commercial kits, such as the Qiagen QIAamp kit (Qiagen, Crawley, UK) may be used. Briefly, the cell sample may be placed in a microcentrifuge tube and combined with Proteinase K, mixed, and allowed to incubate to lyse the cells. Ethanol is then added and the lysate is transferred to a QIAamp spin column from which DNA is eluted after several washings.

The amount of DNA isolated by the particular method used may be quantified to ensure that sufficient DNA is available for the assay and to determine the dilution required to achieve the desired concentration of DNA for PCR amplification. For example, the desired target DNA concentration may be in the range 10 ng and 50 ng. DNA concentrations outside this range may impact the PCR amplification of the individual alleles and thus impact the sensitivity and selectivity of the polymorphism determination step.

The quantity of DNA obtained from a sample may be determined using any suitable technique. Such techniques are well known to persons skilled in the art and include UV (Maniatis, 1982) or fluorescence based methods. As UV methods may suffer from the interfering absorbance caused by contaminating molecules such as nucleotides, RNA, EDTA and phenol and the dynamic range and sensitivity of this technique is not as great as that of fluorescent methods, fluorescence methods are preferred. Commercially available fluorescence based kits such as the PicoGreen dsDNA Quantification (Molecular Probes, Eugene, Oreg., USA).

### Primers

Prior to the testing of a sample, the nucleic acids in the sample may be selectively amplified, for example using Polymerase Chain Reaction (PCR) amplification. as described in U.S. Pat. Nos. 4,683,202 AND 4,683,195.

Preferred primers for use in the present invention are from 18 to 23 nucleotides in length, without internal homology or primer-primer homology.

Furthermore, to ensure amplification of the region of interest and specificity, the two primers of a pair are preferably selected to hybridise to either side of the region of interest so that about 150 bases in length are amplified, although amplification of shorter and longer fragments may also be used. Ideally, the site of polymorphism should be at or near the centre of the region amplified.

Table 1 provides preferred examples of primer pairs which may be used in the invention, particularly when the Taqman® assay is used in the method of the invention. The primers are shown together with the gene targets and preferred examples of the wt probes and polymorphism probes used in the Taqman® assay for each gene target.

Table 2 provides preferred examples of primer pairs which may be used in the invention together with the gene targets and the size of the fragment isolated using the primers, which they amplify.

The primers and primer pairs form a further aspect of the invention. Therefore the invention provides a primer having a sequence selected from SEQ ID NO: 86-99, 104-163. In another aspect, there is provided a primer pair comprising primers having SEQ ID NO:n, where n is an even number from 86-98 or 104-162 in conjunction with a primer having SEQ ID NO: (n+1).

In a preferred embodiment of the invention, multiplexed amplification of a number of sequences are envisioned in order to allow determination of the presence of a plurality of polymorphisms using, for example the DNA array method. Therefore, primer pairs to be used in the same reaction are preferably selected by position, similarity of melting temperature, internal stability, absence of internal homology or homology to each other to prevent self-hybridisation or hybridisation with other primers and lack of propensity of each primer to form a stable hairpin loop structure. Thus, the sets of primer pairs to be co-amplified together preferably have approximately the same thermal profile, so that they can be effectively co-amplified together. This may be achieved by having groups of primer pairs with approximately the same length and the same G/C content.

A primer set may comprise at least 5 primer pairs selected from SEQ ID NOS: 86-121.

Having obtained a sample of DNA, preferably with amplified regions of interest, individual polymorphisms may be identified. Identification of the markers for the polymorphisms involves the discriminative detection of allelic forms of the same gene that differ by nucleotide substitution, or in the case of some genes, for example the GSTM1 and GSTT1 genes, deletion of the entire gene. Methods for the detection of known nucleotide differences are well known to the skilled person. These may include, but are not limited to:

Hybridization with allele-specific oligonucleotides (ASO), (Wallace, 1981; Ikuta, 1987; Nickerson, 1990, Varlaan, 1986, Saiki, 1989 and Zhang, 1991).

Allele specific PCR, (Newton 1989, Gibbs, 1989).

Solid-phase minisequencing (Syvanen, 1993).

oligonucleotide ligation assay (OLA) (Wu, 1989, Barany, 1991; Abravaya, 1995).

The 5′ fluorogenic nuclease assay (Holland, 1991 & 1992, Lee, 1998, U.S. Pat. Nos. 4,683,202, 4,683,195, 5,723,591 and 5,801,155).

Restriction fragment length polymorphism (RFLP), (Donis-Keller, 1987).

In a preferred embodiment, the genetic loci are assessed via a specialised type of PCR used to detect polymorphisms, commonly referred to as the Taqman® assay and performed using an AB7700 instrument (Applied Biosystems, Warrington, UK). In this method, a probe is synthesised which hybridises to a region of interest containing the polymorphism. The probe contains three modifications: a fluorescent reporter molecule, a fluorescent quencher molecule and a minor groove binding chemical to enhance binding to the genomic DNA strand. The probe may be bound to either strand of DNA. For example, in the case of binding to the coding strand, when the Taq polymerase enzyme begins to synthesise DNA from the 5′ upstream primer, the polymerase will encounter the probe and begin to remove bases from the probe one at a time using a 5′-3′ exonuclease activity. When the base bound to the fluorescent reporter molecule is removed, the fluorescent molecule is no longer quenched by the quencher molecule and the molecule will begin to fluoresce. This type of reaction can only take place if the probe has hybridised perfectly to the matched genomic sequence. As successive cycles of amplification take place, i.e. more probes and primers are bound to the DNA present in the reaction mixture, the amount of fluorescence will increase and a positive result will be detected. If the genomic DNA does not have a sequence that matches the probe perfectly, no fluorescent signal is detected.

Examples of oligonucleotide probes which may be used in the invention, particularly when the Taqman® assay is used, include probes having a sequence selected from SEQ ID NOS: 164-202.

### Arrays

In a preferred embodiment of the invention, hybridisation with allele specific oligonucleotides is conveniently carried out using oligonucleotide arrays, preferably microarrays, to determine the presence of particular polymorphisms.

Such microarrays allow miniaturisation of assays, e.g. making use of binding agents (such as nucleic acid sequences) immobilised in small, discrete locations (microspots) and/or as arrays on solid supports or on diagnostic chips. These approaches can be particularly valuable as they can provide great sensitivity (particularly through the use of fluorescent labelled reagents), require only very small amounts of biological sample from individuals being tested and allow a variety of separate assays to be carried out simultaneously. This latter advantage can be useful as it provides an assay for different a number of polymorphisms of one or more genes to be carried out using a single sample. Examples of techniques enabling this miniaturised technology are provided in WO84/01031, WO88/1058, WO89/01157, WO93/8472, WO95/18376/WO95/18377, WO95/24649 and EP-A-0373203, the subject matter of which are herein incorporated by reference.

DNA microarrays have been shown to provide appropriate discrimination for polymorphism detection. Yershov, 1996; Cheung, 1999 and Schena 1999 have described the principles of the technique. In brief, the DNA microarray may be generated using oligonucleotides that have been selected to hybridise with the specific target polymorphism. These oligonucleotides may be applied by a robot onto a predetermined location of a glass slide, e.g. at predetermined X,Y cartesian coordinates, and immobilised. The PCR product (e.g. fluqrescently labelled RNA or DNA) is introduced on to the DNA microarray and a hybridisation reaction conducted so that sample RNA or DNA binds to complementary sequences of oligonucleotides in a sequence-specific manner, and allow unbound material to be washed away. Gene target polymorphisms can thus be detected by their ability to bind to complementary oligonucleotides on the array and produce a signal. The absence of a fluorescent signal for a specific oligonucleotide probe indicates that the client does not have the corresponding polymorphism. Of course, the method is not limited to the use of fluorescence labelling but may use other suitable labels known in the art. the fluorescence at each coordinate can be read using a suitable automated detector in order to correlate each fluorescence signal with a particular oligonucleotide.

Oligonucleotides for use in the array may be selected to span the site of the polymorphism, each oligonucleotide comprising one of the following at a central location within the sequence:

wild-type or normal base at the position of interest in the leading strand

wild-type or normal base at the position of interest in the lag (non-coding) strand
altered base at the position of interest in the leading strand
altered complementary base at the position of interest in the lag strand

An array may comprise a set of two or more oligonucleotides, each oligonucleotide being specific to a sequence comprising one or more polymorphisms of a gene selected from at least one group comprising categories a-k as defined above, preferably an individual gene of each of categories a-k.

For example, an array may comprise oligonucleotides each being specific to a sequence comprising one or more polymorphisms of individual genes, the individual genes comprising each member of the group comprising genes encoding cytochrome P450 monooxygenase, N-acetyltransferase 1, N-acetyltransferase 2, glutathione-S-transferase, manganese superoxide dismutase, 5,10-methylenetetrahydrofolatereductase and alcohol dehydrogenase 2 enzymes. An array may additionally comprise oligonucleotides specific for one or more alleles of the genetic loci of genes encoding one or more, preferably each of epoxide hydrolase (EH), NADPH-quinone reductase (NQ01), paraxonaoase (PON1), myeloperoxidase (MPO), alcohol dehydrogenase 1, alcohol dehydrogenase 3, cholesteryl ester transfer protein, apolipoprotein A IV, apolipoprotein E, apolipoprotein C III, angiotensin, factor VII, prothrombin 20210, β-fibrinogen, heme-oxygenase-1, α-antitrypsin, SPINK1, Δ-aminolevulinacid dehydratase, interleukin 1, interleukin 1, vitamin D receptor, B1 kinin receptor, cystathionine-beta-synthase, methionine synthase (B12 MS), 5-HT transporter, transforming growth factor beta 1 (TGFβ1), L-myc, HLA Class 2 molecules, T-lymphocyte associated antigen 4 (CTLA-4), interleukin 4, interleukin 3, interleukin 6, IgA, and/or galactose metabolism gene GALT. A suitable array may, for example, comprise all of the oligonucleotides SEQ ID NOS:1-85.

### Advice Decision Tree

The results of genetic polymorphism analysis may be used to correlate the genetic profile of the donor of the sample with disease susceptibility using the first dataset, which provides details of the relative disease susceptibility associated with particular polymorphisms and their interactions. The risk factors identified using dataset 1 can then be matched with supplement recommendations from dataset 2 to produce a nutrition plan individualised to the genetic profile of the donor of the sample. Examples of datasets 1 and 2 which may be used to generate such advice is illustrated in FIG. 1.

To enable appropriate advice to be tailored to particular susceptibilities, a ranking system is preferably used to provide an indication of the degree of susceptibility of a specific polymorph to risk of disease including cancer(s) and/or other conditions. The ranking system may be designed to take into account of homozygous or heterozygous alleles in the client's sample, i.e. the same or different alleles being present in diploid nucleus. Five categories which may be used are summarised below:
(i) Reduced susceptibility: where an allele has been shown to reduce susceptibility.
(ii) Normal susceptibility: where allele has been shown to have a normal susceptibility of risk to cancer(s) or disease. This is generally the homozygous wild type allele or a polymorphism that has been shown to have similar function.
(iii) Moderate susceptibility: where a heterozygous genotype is present that contains the wild type of the allele (i.e. normal susceptibility) and an allele of the polymorphism known to give rise to higher susceptibility to specific cancer(s) or disease.
(iv) High susceptibility: where a homozygous genotype that contains the polymorphism is present with a higher risk of cancer susceptibility.
(v) Higher susceptibility: where a higher susceptibility has been observed for specific cancer(s) or disease due to the combined effects of two or more different gene targets.

Using dataset 1, a susceptibility may be assigned to each polymorphism identified and, from dataset 2, a supplement recommendation corresponding to each susceptibility identified may be assigned. For example, if an individual is found to have the NAT1*10 polymorphism, the decision tree may indicate that the there is an enhanced susceptibility of colonic cancer. Nutrition supplement recommendations appropriate to minimising the risk of colonic cancer are then generated. Such supplements may be associated with a protective effect against such cancers. The totality of recommendations may be combined to generate nutrition advice individualised to the donor of the sample. The decision tree is preferably arranged to recognise particular combinations of polymorphisms and/or susceptibilities which interact either positively to produce a susceptibility greater than would be expected from the risk factors associated with each individually, and/or, which interact negatively to reduce the susceptibility associated with each individually. Where such combinations are identified, the advice generated can be tailored accordingly. For example, the combination of NAT2*4 and NAT1*10 polymorphisms have been linked to increased cancer risk (Bell, 1995). Therefore, when such a combination of polymorphisms is identified from a subject's DNA, the associated very high susceptibility to cancer is assigned and the advice tailored accordingly, for example in the type or amount of nutrition supplement recommended.

Table 7 shows examples of databases 1 and 2 which may be used in an embodiment of the present invention.

In generating the advice, other factors such as information concerning the sex and health of the individual and/or of the individual's family, age, alcohol consumption, and existing diet may be used in the determination of appropriate nutrition recommendations.

### Supplement Recommendations and Formulations

Examples of supplements suitable for individuals with polymorphisms in particular genetic loci are shown in table 4.

A supplement may be administered alone, or presented as a nutriceutical composition (e.g. formulation) comprising at least one supplement identified as described above, together with one or more carriers, adjuvants, excipients, diluents, fillers, buffers, stabilisers, preservatives, lubricants, or other materials well known to those skilled in the art. Preferably, the composition comprises two, three, four, five or more supplements.

The formulations may conveniently be presented in a unit dosage form, for example representing a fixed percentage of recommended daily intake of the supplement(s) and may be prepared by any methods well known in the art. In general, the formulations are prepared by uniformly and intimately bringing into association the supplement(s) with liquid carriers or finely divided solid carriers or both, and then if necessary shaping the product.

Formulations are preferably in a form which is suitable for oral administration (e.g. by ingestion) may be presented as discrete units such as capsules, cachets or tablets, each containing a predetermined amount of each of the supplements; as a powder or granules; as a solution or suspension in an aqueous or non-aqueous liquid; or as an oil-in-water liquid emulsion or a water-in-oil liquid emulsion; as a bolus; as an electuary; or as a paste.

A tablet may be made by conventional means, e.g., compression or moulding, optionally with one or more accessory ingredients. Compressed tablets may be prepared by compressing in a suitable machine the active compound in a free-flowing form such as a powder or granules, optionally mixed with one or more binders (e.g. povidone, gelatin, acacia, sorbitol, tragacanth, hydroxypropylmethyl cellulose); fillers or diluents (e.g. lactose, microcrystalline cellulose, calcium hydrogen phosphate); lubricants (e.g. magnesium stearate, talc, silica); disintegrants (e.g. sodium starch glycolate, cross-linked povidone, cross-linked sodium carboxymethyl cellulose); surface-active or dispersing or wetting agents (e.g. sodium lauryl sulfate); and preservatives (e.g. methyl p-hydroxybenzoate, propyl p-hydrox-ybenzoate, sorbic acid). Moulded tablets may be made by moulding in a suitable machine a mixture of the powdered compound moistened with an inert liquid diluent.

Various further aspects and embodiments of the present invention will be apparent to those skilled in the art in view of the present disclosure. All documents mentioned in this specification are incorporated herein by reference in their entirety.

Certain aspects and embodiments of the invention will now be illustrated by way of example and with reference to the tables described above.

### EXPERIMENTAL

### Example 1

### Preparation of DNA Sample

DNA is prepared from a buccal cell sample on a brush using a Qiagen QIAamp kit according to the manufacturer's instructions (Qiagen, Crawley, UK). Briefly, the brush is cut in half and one half stored at room temperature in a sealed tube in case retesting is required. The other half of the brush is placed in a microcentrifuge tube. 400 μl PBS is added and the brush allowed to rehydrate for 45 minutes at room temperature. Quiagen lysis buffer and Proteinase K is then added, the contents are mixed, and allowed to incubate at 56 C for 15 minutes to lyse the cells. Ethanol is added and the lysate transferred to a QIAamp spin column from which DNA is eluted after several washings.

### Example 2

### Quantification of DNA

In order to check that sufficient DNA has been isolated, a quantification step is carried out using the PicoGreen dsDNA Quantification kit (Molecular Probes, Eugene, Oreg., USA).

Briefly, client DNA samples are prepared by transferring a 10 μl aliquot into a microcentrifuge tube with 90 μl TE. 100 μl of the working PicoGreen dsDNA quantification reagent is added, mixed well, and transferred into a black 96 well plate with flat well bottoms. The plate is then incubated for 5 minutes in the dark before a fluorescent reading is taken. The quantity of DNA present in the clients' samples is determined by extrapolating from a calibration plot prepared using DNA standards.

A quantity of DNA in the range of 5-Song total is used in the subsequent PCR step. Remaining client DNA sample is stored at −20° C. for retesting if required.

### Example 3

### Tagman® Assay to Identify the MTHFR A1298C polymorphism

The modified reaction mixture contains Taq polymerase (1.25 units/μl), optimised PCR buffer, dNTP (200 μM each), 2 mM MgCl₂ and primer pairs SEQ ID NO: 160 and 161 and polymorphism probe SEQ ID NO: 200.

The reaction mixture is initially incubated for 10 minutes at 50° C., then 5 minutes at 95° C., followed by 40 cycles of 1 minute of annealing at between 55° C. and 60° C. and 30 seconds of denaturation at 95° C. Both during the cycles and at the end of the run, fluorescence of the released reporter molecules of the probe is measured by an integral CCD detection system of the AB7700 thermocycler. The presence of a fluorescent signal that increases in magnitude through the course of the run indicates a positive result.

The assay is then repeated with the same primer pair and wt probe SEQ ID NO: 199. If the sample is homozygous for the polymorphism, no fluorescence signal is seen with the wt probe. However, if the sample is heterozygous for the polymorphism, a fluorescence signal is also seen with the wt probe. If single reporter results from homozygous wt, homozygous polymorphic and heterozygous polymorphic samples are plotted are plotted on an X/Y axis, the homozygous alleles will cluster at opposite ends of the axes relative to each reporter, and the heterozygous alleles will cluster at a midway region.

### Example 4

### DNA Array Method for Identifying Polymorphisms for Identifying Multiple Polymorphisms

### a) PCR Amplification

The PCR reaction mix contains Taq polymerase (1.25 units/reaction), optimised PCR buffer, dNTP's (200 μM each) and MgCl₂ at an appropriate concentration of between 1 and 4 mM, and 40 pmol of each primer (SEQ ID NOS: 1-8, 17-63) for amplification of seven fragments and the sample DNA.

The reaction mixture is initially incubated at 95° C. for 1 minute, and then subjected to 45 cycles of PCR in a MWG TC9600 thermocycler (MWG-Biotech-AG Ltd., Milton Keynes, UK) as follows:

annealing 50° C., 1 minute
polymerisation 73° C., 1 minute
denaturation 95° C., 30 seconds.

After a further annealing step at 50° C., 1 minute, there is a final polymerisation step at 73° C. for 7 minutes.

(Instead of the MWG TC9600 thermocycler, other thermocyclers, such as the Applied Biosystems 9700 thermocycler (Applied Biosystems, Warrington, UK), may be used.

After amplification of the target genes, generation of product is checked by electrophoresis separation using 2% agarose gel, or a 3.5% NuSieve agarose gel.

The PCR amplification products are then purified using the Qiagen QIAquick PCR Purification Kit (Qiagen, Crawley, UK) to remove dNTPs, primers, and enzyme from the PCR product. The PCR product is layered onto a QIAquick spin column, a vacuum applied to separate the PCR product from the other reaction products and the DNA eluted in buffer.

### b) RNA Transcription and Fluorescent Labelling of PCR Products

The DNA is then transcribed into RNA using T3 and T7 RNA polymerases together with fluorescently labelled UTP for incorporation into the growing chain of RNA. The reaction mixture comprises:

20 μl 5× reaction buffer; 500 μM ATP, CTP, GTP, fluorescent UTP (Amersham Ltd, UK); DEPC treated dH₂O; 1 unit T3 RNA polymerase or 1 unit T7 RNA polymerase (Promega Ltd., Southampton, UK); 1 unit Rnasin ribonuclaese inhibitor and DNA from PCR (⅓ of total, 10 μl in dH₂0).

The mixture is incubated at 37° C. for 1 hour. The mixture is then treated with DNAse to remove DNA so that only newly synthesised fluorescent RNA is left. The RNA is then precipitated, microcentrifuged and resuspended in buffer for hybridisation on the array.

### c) Polymorphism Analysis

The sample amplified fragments are then tested using a DNA microarray

The DNA microarray used comprises oligonucleotides SEQ ID NOs: 1-85. These oligonucleotides are applied by a robot onto a glass slide and immobilised. The fluorescently labelled amplified DNA is introduced onto the DNA microarray and a hybridisation reaction conducted to bind any complementary sequences in the sample, allowing unbound material to be washed away. The presence of bound samples is detected using a scanner. The absence of a fluorescent signal for a specific oligonucleotide probe indicates that the client does not have the corresponding polymorphism.

### Example 5

### DNA Array Method for Identifying G560A Polymorphism

The PCR reaction mix contains Taq polymerase (1.25 units/reaction), optimised PCR buffer, dNTP's (200 μM each) and MgCl₂ at an appropriate concentration of between 1 and 4 mM, and 40 pmol of each primer (SEQ ID NOs: 88,89) for amplification of the fragment. The methods used is the same as detailed in Example 4, with the array comprising oligonucleotides SEQ ID NO: 17, 18, 19 and 20.

The presence of bound samples is detected using a scanner as described above. A highly fluorescent spot is detected at the positions corresponding to the oligonucleotides SEQ ID NO: 19 and 20. No signal is seen at the spots corresponding to SEQ ID NO: 17 and 18, demonstrating that the sample is not heterozygous for the wt allele.

### Example 6

### Generation of Report

The results of the microarray or Taqman® analysis are input into a computer comprising a first dataset correlating the presence of individual alleles with a risk factor and a second dataset correlating risk factors with a nutrition supplement and, optionally, other lifestyle recommendations. A report may then be generated identifying the presence of particular polymorphisms and supplementation advice based on the identified polymorphisms. An example of such a decision process is shown in FIG. 2. The supplementation advice may comprise a recipe for a formulation comprising the nutrition supplements thus identified. In some embodiments, the ingredients for preparing this formulation or the formulation itself may be provided.

To generate the supplement formula, the alleles are correlated with lifestyle risk factors from dataset 1 and then matched with supplements from dataset 2. For example, the presence of the MTHFR C677T polymorphism leads to a thermolabile enzyme that is less efficient at metabolising folate, a key step in the methionine recovery pathway. The recommended supplement formulation for an individual with the polymorphism may comprise some or all of the following supplements: riboflavin, niacin, vitamin B6, folate, vitamin B12 and L-serine. Quantities of each component in the formulation may depend on the number of variant alleles and the presence or absence of variants in other genes involved in the folate metabolism pathway. The supplement recipe and optionally, lifestyle recommendations, are then assembled to generate a comprehensive personalised lifestyle advice plan.

Optionally, lifestyle recommendations may be generation by providing a fourth dataset (dataset 4) in which the risk factors of dataset 1 are matched with one or more lifestyle recommendations. As described above, the sample of DNA from the individual is screened and the alleles identified input to a dataprocessor as Dataset 3. Each allele is matched to lifestyle risk factor from dataset 1, e.g. high susceptibility to colon cancer due to the presence of the NAT1*10 allele and the absence of the GSTM1 allele. The identified risk factor is then matched with one or more lifestyle recommendations from dataset 4, for example “avoid red meat, chargrilled food, smoked meats and fish; stop smoking immediately” (in order to avoid production of potentially toxic byproducts by Phase 1 enzymes with increased activity) and “increase consumption of vegetables of the allium family e.g. onions and garlic, and the brassaicae family e.g. broccoli” (in order to increase the activity of Phase II enzymes present, such as GSTP1 and GSTT1 and others, in order to increase the excretion of toxic byproducts of Phase 1 metabolism). This is then checked against other factors input into the data processor, e.g. age, sex and existing diet to modify the recommendation accordingly before generating the final recommendation appropriate to the allele.

### REFERENCES

Abravaya, K. et al (1995) Nucleic Acids Research. 23:675-682.
Agarwal, K. et al 2000 J Hepatol, 32, 4, p. 538-541.
Alexandrie, A.-K. et al Carcinogenesis 21(4)669-676, 2000.
Ambrosone, C. B. et al Cancer Research 59: 602-606, 1999.
Ames, B. N. PNAS 96(22): 12216-12218, 1999.
Aron, Y. et al (1994) Allergy 49 (9): 788-90.
Ban, Y. & Taniyama, M. 2000 J Clin Endocrinol Metab, 85, 12, p. 4639-4643.
Barany, F. 1991 PNAS USA 88:189-193.
Bell, D. A et al Cancer Research 55: 3537-3542, 1995.
Bosron, W. F. and Li, T. K. Hepatology 6: 502-510, 1986.
Brand, E. et al 2000, Herz, 25, 1, p. 15-25.
Breslauer, et al. Proc. Nat'l Acad. Sci. USA, 83: 3746-3750 (1986)
Brockton, N. et al. American Journal of Epidemiology 151(9): 846-861, 2000.
Bryant, M. S., et al Cancer Research 47: 612-618, 1987.
Buervenich, S. et al., 2000 Mov Disord, 15, 5, p. 813-818.
Bullido, M. J. et al 2000 Microsc Res Tech, 50, 4, p. 261-267.
Cheung, V. G., et. al. 1999, Nature, Genetics, vol. 21, 15-19.
Corbo, R. M. & Scacchi, R., 1999 Ann Hum Genet, 63, PT4, p. 301-310.
Costa, L. G., 2000 Neurotoxicology, 21, 1-2, p. 85-89.
Cotton, S. C. et al American Journal of Epidemiology 151(1)7-32, 2000.
Cramer, D. W. et al 2000 Cancer Epidemiol Biomarkers Prev, 9, 1, p. 95-101.
Cramer, D. W. et al 2000 Cancer Epidemiol Biomarkers Prev, 9, 1, p. 95-101.
de Padua Mansur, A. et al 2000. Am J Cardiol 85 (9): 1089-93.
Di Castelnuovo, A et al 2000 Thromb Res, 98, 1, p. 9-17.
Dickey, C. et al Risk Analysis 17: 649-655, 1997.
Dietz, A. C. et al Proceedings of the American Association for Cancer Research, 40: 148, 1999.
Doll, M. A. et al. Biochem. Biophys. Res. Commun. 233: 584-591, (1997)
Donati, M. B. et al 2000, J Hum Hypertens, 14, 6, p. 369-372.
Donis-Keller H., et. al. (1987) Cell, 51, 319-337
Eberhart, M. V. et al Nature 405: 903-904, 2000.
Casamitjana, R., et al 2000, Diabetes Care, 23, 6, p. 831-837.
Garte, S. Carcinogenesis 19(8) 1329-1332, 1998.
Gelder, C. M. et al 2000 J Infect Dis, 181, 6, p. 2099-2102.
Gibbs, R. A. et al. 1989 Nucleic Acids Research. 17:2437-2448.
Gil, J. P., Lechner, M. C. Carcinogenesis 19(1) 37-41, 1998.
Giovannucci, E. Advances in Experimental Medicine and Biology 472:29-42, 1999.
Fung, S. et al. 1994. Nucleic Acid Research. 22:4527-4534.
Harries, L. W. et al Carcinogenesis 18:641-644, 1997.
Hattis D. et al Human Variability in Parameters that are Potentially Related to Susceptibility to Carcinogenesis-I. Preliminary Observations. Center for Technology, Policy and Industrial Development, MIT, Cambridge, Mass., 1986.
Heilbronn, L. K et al 2000, Atherosclerosis, 150, 1, p. 187-192.
Hein, D., et al Cancer Epidemiology, Biomarkers & Prevention 9: 29-42, 2000 (a).
Hein, D. Toxicology Letters 112-113: 349-356, 2000 (b).
Hennig, B. J. et al. 1999 J Periodontol, 70, 9, p. 1032-1038.
Hirvonen, A. Environ Health Perspect 107 Supplement 1: 37-47, 1999.
Humphries, S. E. et al 1999 Blood Coagul Fibrinolysis, 10 Suppl 1, p. S17-S21.
Ikuta S. et al 1987 Nucleic Acids Research. 15:797-811.
Ilett, K. F. et al Cancer Research 47: 1466-1469, 1987.
International Agency for Research on Cancer (IARC). Alcohol Drinking. IARC monographs on the evaluation of the carcinogenic risks to humans, IARC, Lyon. 44: 153-246, 1998.
Kato, S. et al Journal of the National Cancer Institute 87:902-907, 1995.
Kawajiri, K. et al. Cancer Research 56:72-76, 1996.
Landegren, U. et al 1988. Science. 241:1077-1080.
Laplaud, P. M. 1998 Clin Chem Lab Med, 36, 7, p. 431-441.
Layton, D. W. et al Carcinogenesis 16: 39-52, 1995.
Lee, E. et al Journal of the Toxicological Society 23: 140-142, 1998.
Maciag, P. C. et al 2000 Cancer Epidemiol Biomarkers Prev, 9, 11, p. 1183-1191.
MacKness, B. et al 2000 Eur J Clin Invest, 30, 1, p. 4-10.
MacLeod, S. et al Mutation Research 376(1-2): 135-142, 1997.
Maniatis T. et al (1982) Molecular Cloning A Laboratory Manual, Cold Spring Harbor Laboratory, Cold Springs Harbor, N.Y.
Marchand, L. L. et al 1999, Cancer Epidemiol Biomarkers Prev, 8, 6, p. 495-500.
Matthias, C. et al, Pharmacogenetics 8: 1-6, 1997.
Miki, M. & Satoh, K., 1999 Nippon Rinsho, 57, 9, p. 1954-1958.
Mooney, L. A., Perera, F. P. Journal of Cellular Biochemistry Supplement 25:63-8, 1996.
Mooney, L. A. et al. Cancer Epidemiological Biomarkers Prevention 4: 627-634, 1995.
Nakajima, T. & Aoyama, T., 2000 Ind Health, 38, 2, p. 143-152.
Newton, C. R. et al 1989 Nucleic Acids Research. 17:2503-2516.
Nickerson, D. A. et al. 1990 PNAS USA 87:8923-8927.
Oliveira, J. R. et al 1999, Braz J Med Biol Res, 32, 4, p. 463-467.
Ordovas, J. M. et al 2000 Arterioscler Thromb Vasc Biol, 20, 5, p. 1323-1329.
Ota, N et al 1999 Hum Genet, 105, 3, p. 253-257.
Perera, F. P. Environmental Health Perspectives 103 Suppl 8: 233-6, 1995.
Perera, F. P. Biomarkers and Molecular Epidemiology of Cancer. Proceedings of the 9^{th} International Symposium in Epidemiology in Occupational Health. National Institute for Occupational Safety and Health, Cincinnati, Ohio. PP 54-66, 1992.
Perera, F. P. Science 278: 1068-1073, 1997.
Perera, F. P. and Weinstein I. B. Carcinogenesis 21 (3): 517-524, 2000.
Pfutzer, R. H. et al 2000 Gastroenterology, 119, 3, p. 615-623.
PicoGreen dsDNA Quantitation Reagent and Kit Instruction, (1996) Molecular Probes, Eugene, Or.
Pluth, J. M et al 2000 Pharmacogenetics, 10, 4, p. 311-319.
Poolsup, N. et al 2000 J Clin Pharm Ther, 25, 3, p. 197-220.
Potter, J. D. Journal of the National Cancer Institute 91(11): 916-932, 1999.
Raknes, G. et al 2000 J Neurol Sci, 175, 2, p. 111-115.
Roggia, C. et al (2001). Proc Natl Acad Sci USA 98, 13960-13965.
Rojas, M. et al Carcinogenesis 21(1): 35-41, 2000.
Rosa-Rosa, L. et al (1999) J Allergy Clin Immunol, 104, 5, p. 1008-1014.
Ryberg, D. et al Carcinogenesis 18:1285-1289, 1997.
Rylchik, W., “Selection of Primers for Polymerase Chain Reaction”, Methods in Molecular Biology, Vol. 15: PCR Protocols: Current Methods and Applications, pp 31-40 (1993) Humana Press.
Saiki, R. K. et al 1989 PNAS. USA 86:6230-6234.
Salas, J. et al 1998 μm J Clin Nutr, 68, 2, p. 396-401.
Schabath, M. B. et al 2000 Carcinogenesis, 21, 6, p. 1163-1166.
Schena, M., 1999, DNA Microarrays “a practical approach”, ISBN, 0-19-963777-6, Oxford press, editor B. D. Hames
Shields, P. G., Harris, C. C. Journal of Clinical Oncology 18(11) 2309-2315, 2000.
Sinha, R. et al 1997 Ann Epidemiol, 7, 5, p. 350-356.
Sinha, R. et al Cancer Research 59: 4320-4324, 1999.
Smith, G. et al Cancer Surveys 25: 27-65, 1995.
Syvanen, A. C. et al 1993. American Journal of Human Genetics. 52:46-59.
Taningher, M. et al Mutation Research 436: 227-261, 1999.
Thomas, P. S. (2001). Immunol Cell Biol 79, 132-140.
Togo, A. V. et al 2000 Int J Cancer, 85, 6, p. 747-750.
Tsai, M. Y. et al 1999 Atherosclerosis, 143, 1, p. 163-170.
Ulrich, C. M. et al Cancer Epidemiological Biomarkers Prevention 8: 659-668, 1999.
Verlaan-de Vries, M. et al (1986) Gene 50:313-320.
Vicente, V. et al 1999 Haematologica, 84, 4, p 356-362.
Vineis, P International Journal of Cancer 71: 1-3, 1997.
Wallace, A. J. et al 2000 Atherosclerosis, 149, 2, p 387-394.
Wallace, R. B et al 1981 Nucleic Acids Research. 9:879-894.
Wilkinson, R. J. et al 2000 Lancet, 355, 9204, p. 618-621.
World Cancer Research Fund (WCRF) Panel. (Potter, J. D. Chair) Diet, nutrition, and the prevention of cancer: a global perspective. Washington, D.C.: WCRF/American Institute of Cancer Research, 1997.
Wu, D. Y., and Wallace, R. B. 1989. Genomics. 4:560-569.
Yamada, N. et al 2000 μm J Hum Genet, 66, 1, p. 187-195.
Yershov, G., Barsky, V., et. al., 1996, Proc. Natl. Acad. Sci. USA, Genetics, Vol. 93, 4913-4918.
Yokota, M. et al 2000 Circulation, 101, 24, p. 2783-2787.
Yokoyama, A. et al Carcinogenesis 19(8)1383-1387, 1998.
Zhang, Y. et al 1991 Nucleic Acids Research. 19: 3929-3933.
Zheng, W. et al Cancer Epidemiological Biomarkers Prevention 8: 233-239, 1999.
Zychma, M. J et al 1999 J Am Soc Nephrol, 10, 10, p. 2120-2124.

TABLE 1

| | Forward | Reverse | | Polymorphism |
|---|---|---|---|---|
| Gene | primer | primer | WT Probe | probe |
| 1. CYP1A1 | | | | |
| A4889G | CATGGGCAAGCGGA | CAGGATAGCCAGG | CGGTGAGACCaTTG | CGGTGAGACCgTT |
| | AGTG | AAGAGAAAGAC | (SEQ ID NO:164) | G |
| | (SEQ ID NO:122) | (SEQ ID NO:123) | | (SEQ ID NO:165) |
| T6235C | AGACAGGGTCCCCA | CAGAGGCTGAGGT | CTCCACCTCCtGGG | CTCCACCTCCcGG |
| | GGTCAT | GGGAGAA | (SEQ ID NO:166) | G |
| | (SEQ ID NO:124) | (SEQ ID NO:125) | NO:166) | (SEQ ID NO:167) |
| 2. NAT1 | | | | |
| G445A | GGAGTTAATTTCTG | TGGTCTAGATACC | GCCTTGTgTCTTC | TGCCTTGTaTCTT |
| | GGAAGGATCAG | AGAATCCATTCTC | (SEQ ID NO:168 | C |
| | (SEQ ID NO:126) | TT | | (SEQ ID NO:169) |
| | | (SEQ ID NO:127) | | |
| G459A | GGCAGCCTCTGGAG | TTCCCTTCTGATT | CGTTTGACgGAAGA | CGTTTGACaGAAG |
| | TTAATTTCT | TGGTCTAGATACC | G | AG |
| | (SEQ ID NO:128) | (SEQ ID NO:129) | (SEQ ID NO:171) | (SEQ ID NO:171) |
| G560A | GGGAACAGTACATT | TGTTCGAGGCTTA | AATACCgAAAAATC | CAAATACCaAAAA |
| | CCAAATGAAGA | AGAGTAAAGGAGT | (SEQ ID NO:172) AT | |
| | (SEQ ID NO:130) | (SEQ ID NO:131) | | (SEQ ID NO:173) |
| T640G | AACAATTGAAGATT | TCTGCAAGGAACA | CATCTCCAtCATCT | ACATCTCCAgCAT |
| | TTGAGTCTATGAAT | AAATGATTTACTA | G | CT |
| | ACA | GT | (SEQ ID NO:174) | (SEQ ID NO:175) |
| | (SEQ ID NO:132) | (SEQ ID NO:133) | | |
| T1088A | GAAACATAACCACA | AAATCACCAATTT | CCATCTTTAAAATA | CATCTTTAAAATA |
| | AACCTTTTCAAA | CCAAGATAACCA | CATTTaTTA | CATTTtTTA |
| | (SEQ ID NO:134) | (SEQ ID NO:135) | (SEQ ID NO:203) | (SEQ ID NO:204) |
| C1095A | AAACATAACCACAA | AAATCACCAATTT | GCCATCTTTAAAAg | GCCATCTTTAAAA |
| | ACCTTTTCAAATAA | CCAAGATAACCA | ACAT | tACATT |
| | T | (SEQ ID NO:137) | (SEQ ID NO:176) | (SEQ ID NO:177) |
| | (SEQ ID NO:136) | | | |
| 3. NAT2 | | | | |
| C > T | AATCAACTTCTGTA | CCATGCCAGTGCT | AGGGTATTTTTAcA | AGGGTATTTTTAt |
| | CTGGGCTCTGA | GTATTTGTT | TCCCT | ATCCCTC |
| | (SEQ ID NO:138) | (SEQ ID NO:139) | (SEQ ID NO:178) | (SEQ ID NO:179) |
| C > T2 | TGCATTTTCTGCTT | TTTGTTTGTAATA | TCTGGTACCTGGAC | AATCTGGTACtTG |
| | GACAGAAGA | TACTGCTCTCTCC | CAA | GACCAA |
| | (SEQ ID NO:140) | TGAT | (SEQ ID NO:180) | (SEQ ID NO:181) |
| | | (SEQ ID NO:141) | | |
| G > A | GCCAAAGAAGAAAC | AAATGATGTGGTT | TGAACCTCgAACAA | TTGAACCTCaAAC |
| | ACCAAAAAAT | ATAAATGAAGATG | T | AATT |
| | (SEQ ID NO:142) | TTG | (SEQ ID NO:182) | (SEQ ID NO:183) |
| | | (SEQ ID NO:143) | | |
| G > A2 | AAGAGGTTGAAGAA | ATACATACACAAG | CTGGTGATGgATCC | CTGGTGATGaATC |
| | GTGCTGAAAAATAT | GGTTTATTTTGTT | (SEQ ID NO:184) | C |
| | (SEQ ID NO:144) | CCT | | (SEQ ID NO:185) |
| | | (SEQ ID NO:145) | | |
| 4. GSTM1 | | | | |
| C534G | GTTCCAGCCCACAC | CGGGAGATGAAGT | CAAGCAgTTGGGC | CAAGCAcTTGGGC |
| | ATTCTTG | CCTTCAGATT | (SEQ ID NO:186) | (SEQ ID NO:186) |
| | (SEQ ID NO:146) | (SEQ ID NO:147) | | |
| 5. | GSTP1 | | | |
| A313G | CCTGGTGGACATGG | GCAGATGCTCACA | GCAAATACaTCTCC | GCAAATACgTCTC |
| | TGAATG | TAGTTGGTGTAG | CT | CCT |
| | (SEQ ID NO:148) | (SEQ ID NO:149) | (SEQ ID NO:188) | (SEQ ID NO:189) |
| C341T | GGGATGAGAGTAGG | GGGTCTCAAAAGG | CCTTGCCCgCCTC CTTGCCCaCCTCC | |
| | ATGATACATGGT | CTTCAGTTG | (SEQ ID NO:190) | (SEQ ID NO:191) |
| | (SEQ ID NO:150) | (SEQ ID NO:151) | | |
| 6. GSTT1 | TCATTCTGAAGGCC | CAGGGCATCAGCT | CCTGCAGACCCC | N/A |
| | AAGGACTT | TCTGCTT | (SEQ ID NO:192) | |
| | (SEQ ID NO:152) | (SEQ ID NO:153) | | |
| 7. MnSOD | | | | |
| T-28C | GGCTGTGCTTTCTC | TTCTGCCTGGAGC | ACCCCAAAaCCGGA | ACCCCAAAgCCGG |
| | GTCTTCA | CCAGAT | (SEQ ID NO:193 | A |
| | (SEQ ID NO:154) | (SEQ ID NO:155) | | (SEQ ID NO:194) |
| T175C | GTGTTGCATTTACT | TCCAGAAAATGcT | AGCCCAGAtAGCT AGCCCAGAcAGCT | |
| | TCAGGAGATGTT | ATGATTGATATGA | (SEQ ID NO:195) | (SEQ ID NO:196) |
| | (SEQ ID NO:156) | C | | |
| | | (SEQ ID NO:157) | | |
| 8. MTHFR | | | | |
| C677T | GACCTGAAGCACTT | TCAAAGAAAAGCT | AAATCGgCTCCCGC | AAATCGaCTCCCG |
| | GAAGGAGAA | GCGTGATGA | (SEQ ID NO:197) | CAGA |
| | (SEQ ID NO:158) | (SEQ ID NO:159) | | (SEQ ID NO:198) |
| A1298C | AAGAGCAAGTCCCC | CTTTGTGACCATT | CAGTGAAGaAAGTG | AGTGAAGcAAGTG |
| | CAAGGA | CCGGTTTG | TC | TC |
| | (SEQ ID NO:160) | (SEQ ID NO:161) | (SEQ ID NO:199) | (SEQ ID NO:200) |
| 9. ALDH2 | | | | |
| G1156A | CCCTTTGGTGGCTA | AGACCCTCAAGCC | TCACAGTTTTCACT | TCACAGTTTTCAC |
| | CAAGATGT | CCAACA | TcAGTGT | TTtAGTGT |
| | (SEQ ID NO:162) | (SEQ ID NO:163) | (SEQ ID NO:201) | (SEQ ID NO:202) |

TABLE 2

| | Primer | | | |
|---|---|---|---|---|
| Gene | Set | Forward | Reverse | Size |
| NAT1 | 1 | N/A same genotype as | | |
| | set 3 | | | |
| | 2 | N/A same genotype as | | |
| | | set 3 | | |
| | 3 | 5′ggg ttt gga cgc tca | 5′aat gta ctg ttc cct tct | 141 bp |
| | | tac c | gat ttg g | |
| | | (SEQ ID NO:86) | (SEQ ID NO:87) | |
| | 4b | 5′tcc gtt tga cgg aag | 5′ggg tct gca agg aac aaa | 234 bp |
| | | aga at | at | |
| | | (SEQ ID NO:88) | (SEQ ID NO:89) | |
| | 5 | 5′gaa aca taa cca caa | 5′caa caa taa acc aac att | 241 bp |
| | | acc | aaa agc | |
| | | (SEQ ID NO:90) | (SEQ ID NO:91) | |
| NAT2 | 1 | 5′act tct gta ctg ggc | 5′gca tcg aca atg taa ttc | 150 bp |
| | | tct gac c | ctg c | |
| | | (SEQ ID NO:92) | (SEQ ID NO:93) | |
| | 2 | 5′aat aca gca ctg gca | 5′caa gga aca aaa tga tgt | 380 bp |
| | | tgg | gg | |
| | | (SEQ ID NO:94) | (SEQ ID NO:95) | |
| | 3 | 5′gtg ggc ttc atc ctc | 5′ggg tga tac ata cac aag | 209 bp |
| | | acc ta | ggt tt | |
| | | (SEQ ID NO:96) | (SEQ ID NO:97) | |
| GSTN1 | 1 | 5′cag ccc aca cat tct | 5′aag cgg gag atg aag tcc | 196 bp |
| | | tgg | | |
| | | (SEQ ID NO:98) | (SEQ ID NO:99) | |
| MTHFR | 1 | 5′agg tta ccc caa agg | 5′gca agt gat gcc cat gtc g | 166bp |
| | | cca cc | | |
| | | (SEQ ID NO:100) | (SEQ ID NO:101) | |
| | 2 | 5′tct tct acc tga aga | 5′caa gtc act ttg tga cca | 142 bp |
| | | gca agt cc | ttc c | |
| | | (SEQ ID NO:102) | (SEQ ID NO:103) | |
| CYP1A1 | 1b | 5′cct gaa ctg cca ctt | 5′cca gga aga gaa aga cct | 199 bp |
| | | cag c | cc | |
| | | (SEQ ID NO:104) | (SEQ ID NO:105) | |
| | 2 | 5′ccc att ctg tgt ttg | 5′aga ggc tga ggt ggg aga | 213 bp |
| | | ggt ttt t | at | |
| | | (SEQ ID NO:106) | (SEQ ID NO:107) | |
| GSTT1 | 1 | 5′gag gtc att ctg aag | 5′ttt gtg gac tgc tga gga | 133 bp |
| | | gcc aag g | cg | |
| | | (SEQ ID NO:108) | (SEQ ID NO:109) | |
| β | 1b | 5′tcc tca gat cat tgc | 5′taa cgc aac taa gtc ata | 175 bp |
| actin | | tcc | gtc c | |
| | | (SEQ ID NO:110) | (SEQ ID NO:111) | |
| MnSOD | 1 | 5′ggc tgt gct ttc tcg | 5′ggt gac gtt cag gtt gtt | 194 bp |
| | | tct tc | ca | |
| | | (SEQ ID NO:112) | (SEQ ID NO:113) | |
| | 2 | 5′aca gtg gtt gaa aaa | 5′caa aat gta gat aag ggt | 205 bp |
| | | gta gg | gc | |
| | | (SEQ ID NO:114) | (SEQ ID NO:115) | |
| ALDH2 | 1 | 5′ttg gtg gct aca aga | 5′agg tcc tga act tcc agc | 345 bp |
| | | tgt cg | ag | |
| | | (SEQ ID NO:118) | (SEQ ID NO:117) | |
| GSTP1 | 1 | 5′gct cta tgg gaa gga | 5′aag cca cct gag ggg taa | 192 bp |
| | | cca gc | gg | |
| | | (SEQ ID NO:118) | (SEQ ID NO:119) | |
| | 2 | 5′cag cag ggt ctc aaa | 5′gat gga cag gca gaa tgg | 250 bp |
| | | agg | | |
| | | (SEQ ID NO:120) | (SEQ ID NO:121) | |

TABLE 3

| | |
|---|---|
| Gene Target | 25 nt sequence |

| | |
|---|---|
| 1. CYP1A1 | |
| Primer set1 A4889G wt-lead | 5′atc ggt gag acc Att gcc cgc tgg g |
| | (SEQ ID NO:1) |
| Primer set1 A4889G wt-lag | 5′ccc agc ggg caa Tgg tct cac cga t |
| | (SEQ ID NO:2) |
| Primer set1 A4889G polymorph- | 5′atc ggt gag acc Gtt gcc cgc tgg g |
| lead | (SEQ ID NO:3) |
| Primer set1 A4889G polymorph-lag | 5′ccc agc ggg caa Cgg tct cac cga t |
| | (SEQ ID NO:4) |
| Primer set2 T6235C wt-lead | 5′acc tcc acc tcc Tgg gct cac acg a |
| | (SEQ ID NO:5) |
| Primer set2 T6235C wt-lag | 5′tcg tgt gag ccc Agg agg tgg agg t |
| | (SEQ ID NO:6) |
| Primer set2 T6235C polymorph-lead | 5′acc tcc acc tcc Cgg gct cac acg a |
| | (SEQ ID NO:7) |
| Primer set2 T6235C polymorph-lag | 5′tcg tgt gag ccc Ggg agg tgg agg t |
| | (SEQ ID NO:8) |
| 2. NAT1 | |
| Primer set1 | N/A |
| Primer set2 | N/A |
| Primer set 3 G445A wt-lead | 5′cag gtg cct tgt Gtc ttc cgt ttg a |
| | (SEQ ID NO: 9) |
| Primer set3 G445A wt-lag | 5′tca aac gga aga Cac aag gca cct g |
| | (SEQ ID NO:10) |
| Primer set3 G445A polymorph-lead | 5′cag gtg cct tgt Atc ttc cgt ttg a |
| | (SEQ ID NO:11) |
| Primer set3 G445A polymorph-lag | 5′tca aac gga aga Tac aag gca cct g |
| | (SEQ ID NO:12) |
| Primer set3 G459A wt-lead | 5′ctt ccg ttt gac Gga aga gaa tgg a |
| | (SEQ ID NO:13) |
| Primer set3 G459A wt-lag | 5′tcc att ctc ttc Cgt caa acg gaa g |
| | (SEQ ID NO:14) |
| Primer set3 G459A polymorph-lead | 5′ctt ccg ttt gac Aga aga gaa tgg a |
| | (SEQ ID NO:15) |
| Primer set3 G459A polymorph-lag | 5′tcc att ctc ttc Tgt caa acg gaa g |
| | (SEQ ID NO:16) |
| Primer set4 G560A wt-lead | 5′aca gca aat acc Gaa aaa tct act c |
| | (SEQ ID NO:17) |
| Primer set4 G560A wt-lag | 5′gag tag att ttt Cgg tat ttg ctg t |
| | (SEQ ID NO:18) |
| Primer set4 G560A polymorph-lead | 5′aca gca aat acc Aaa aaa tct act c |
| | (SEQ ID NO:19) |
| Primer set4 G560A polymorph-lag | 5′gag tag att ttt Tcc tat ttg ctg t |
| | (SEQ ID NO:20) |
| Primer set5 T1088A wt-lead*a | 5′taa taa taa taa Taa atg tct ttt a |
| | (SEQ ID NO:21) |
| Primer set5 T1088A wt-lag*a | 5′taa aag aca ttt Att att att att a |
| | (SEQ ID NO:22) |
| Primer set5 T1088A wt-lead*b | 5′taa taa taa taa Taa atg tat ttt a |
| | (SEQ ID NO:23) |
| Primer set5 T10BBA wt-lag*b | 5′taa aat aca ttt Att att tta att a |
| | (SEQ ID NO:24) |
| Primer set5 T1088A polymorph- | 5′taa taa taa taa Aaa atg tct ttt a |
| lead*a | (SEQ ID NO:25) |
| Primer set5 T1088A polymorph- | 5′taa aag aca ttt Ttt att tta att a |
| lag*a | (SEQ ID NO:26) |
| Primer set5 T1088A polymorph | 5′taa taa taa taa Aaa atg tat ttt a |
| lead*b | (SEQ ID NO:205) |
| Primer set5 T1088A polymorph- | 5′taa aat aca ttt Ttt att tta att a |
| lag*b | (SEQ ID NO:27) |
| *redundancy due to adjacent | |
| polymorphisms | |
| Primer set5 C1095A wt-lead*a | 5′aat aat aaa tgt Ctt tta aag atg g |
| | (SEQ ID NO:28) |
| Primer set5 C1095A wt-lag*a | 5′cca tct tta aaa Gac att tat tat t |
| | (SEQ ID NO:29) |
| Primer set5 C1095A wt-lead*b | 5′aat aaa aaa tgt Ctt tta aag atg g |
| | (SEQ ID NO:30) |
| Primer set5 C1095A wt-lag*b | 5′cca tct tta aaa Gac att ttt tat t |
| | (SEQ ID NO:31) |
| Primer set5 C1095A polymorph- | 5′aat aat aaa tgt Att tta aag atg g |
| lead*a | (SEQ ID NO:32) |
| Primer set5 C1095A polymorph- | 5′cca tct tta aaa Tac att tat tat t |
| lag*a | (SEQ ID NO:33) |
| Primer set5 C1095A polymorph-lead*b | 5′aat aaa aaa tgt Att tta aag atg g |
| | (SEQ ID NO:34) |
| Primer set5 C1095A polymorph- | 5′cca tct tta aaa Tac att ttt tat t |
| lag*b | (SEQ ID NO:35) |
| *redundancy due to adjacent | |
| polymorphisms | |
| 3. NAT2 | |
| Primer set1 C282T wt-lead | 5′agg gta ttt tta Cat ccc tcc agt t |
| | (SEQ ID NO:36) |
| Primer set1 C282T wt-lag | 5′aac tgg agg gat Gta aaa ata ccc t |
| | (SEQ ID NO:37) |
| Primer set1 C282T polymorph-lead | 5′agg gta ttt tta Tat ccc tcc agt t |
| | (SEQ ID NO:38) |
| Primer set1 C282T polymorph-lag | 5′aac tgg agg gat Ata aaa ata ccc t |
| | (SEQ ID NO:39) |
| Primer set2 C481T wt-lead | 5′gga atc tgg tac Ctg gac caa atc a |
| | (SEQ ID NO:40) |
| Primer set2 C481T wt-lag | 5′tga ttt ggt cca Ggt acc aga ttc c |
| | (SEQ ID NO:41) |
| Primer set2 C481T polymorph-lead | 5′gga atc tgg tac Ttg gac caa atc a |
| | (SEQ ID NO:42) |
| Primer set2 C481T polymorph-lag | 5′tga ttt ggt cca Agt acc aga ttc c |
| | (SEQ ID NO:43) |
| Primer set2 G590A wt-lead | 5′cgc ttg aac ctc Gaa caa ttg aag a |
| | (SEQ ID NO:44) |
| Primer set2 G590A wt-lag | 5′tct tca att gtt cga ggt tca agc g |
| | (SEQ ID NO:45) |
| Primer set2 G590A polymorph-lead | 5′cgc ttg aac ctc Aaa caa ttg aag a |
| | (SEQ ID NO:46) |
| Primer set2 G590A polymorph-lag | 5′tct tca att gtt Tga ggt tca agc g |
| | (SEQ ID NO:47) |
| Primer set3 G857A wt-lead | 5′aac ctg gtg atg Gat ccc tta cta t |
| | (SEQ ID NO:48) |
| Primer set3 G857A wt-lag | 5′ata gta agg gat Cca tca cca ggt t |
| | (SEQ ID NO:49) |
| Primer set3 G857A polymorph-lead | 5′aac ctg gtg atg Aat ccc tta cta t |
| | (SEQ ID NO:50) |
| Primer set3 G857A polymorph-lead | 5′ata gta agg gat Tca tca cca ggt t |
| | (SEQ ID NO:51) |
| 4. GSTM1 | |
| Primer set1 wt-lead | 5′gct aca ttg ccc gca agc aca acc t |
| | (SEQ ID NO:52) |
| Primer set1 wt-lag | 5′agg ttg tgc ttg cgg gca atg tag c |
| | (SEQ ID NO:53) |
| 5. QSTP1 | |
| Primer set1 A313G wt-lead | 5′cgc tgc aaa tac Atc tcc ctc atc t |
| | (SEQ ID NO:54) |
| Primer set1 A313G wt-lag | 5′aga tga ggg aga Tgt att tgc agc g |
| | (SEQ ID NO:55) |
| Primer set1 A313G polymorph-lead | 5′cgc tgc aaa tac Gtc tcc ctc atc t |
| | (SEQ ID NO:56) |
| Primer set1 A313G polymorph-lag | 5′aga tga ggg aga Cgt att tgc agc g |
| | (SEQ ID NO:57) |
| Primer set2 C341T wt-lead | 5′tct ggc agg agg cgg gca agg atg a |
| | (SEQ ID NO:58) |
| Primer set2 C341T wt-lag | 5′tca tcc ttg ccc Gcc tcc tgc cag a |
| | (SEQ ID NO:59) |
| Primer set2 C341T polymorph-lead | 5′tct ggc agg agg Tgg gca agg atg a |
| | (SEQ ID NO:60) |
| Primer set2 C341T polymorph-lag | 5′tca tcc ttg ccc Acc tcc tgc cag a |
| | (SEQ ID NO:61) |
| 6. GSTT1 | |
| Primer set1 wt-lead | 5′acc ata aag cag aag ctg atg ccc t |
| | (SEQ ID NO:62) |
| Primer set2 wt-lag | 5′agg gca tca gct tct gct tta tgg t |
| | (SEQ ID NO:63) |
| 7. MnSOD | |
| Primer set1 T-26C wt-lead | 5′agc tgg ctc cgg Ttt tgg gt atc t |
| | (SEQ ID NO:64) |
| Primer set2 T-26Cwt lag | 5′aga tac ccc aaa Acc gga gcc agc t |
| | (SEQ ID NO:65) |
| Primer set1 T-26C polymorph-lead | 5′agc tgg ctc cgg Ctt tgg ggt atc t |
| | (SEQ ID NO:66) |
| Primer set1 T26C polymorph-lag | 5′aga tac ccc aaa Gcc gga gcc agc t |
| | (SEQ ID NO:67) |
| Primer set2 T175C wt-lead | 5′tta cag ccc aga Tag ctc ttc agc C |
| | (SEQ ID NO:68) |
| Primer set2 T175C wt-lag | 5′ggc tga aga gct Atc tgg gct gta a |
| | (SEQ ID NO:69) |
| Primer set2 T175C polymorph- | 5′tta cag ccc aga Cag ctc ttc agc c |
| lead | (SEQ ID NO:70) |
| Primer set2 Tl75C polymorph-lag | 5′ggc tga aga gct Gtc tgg gct gta a |
| | (SEQ ID NO:71) |
| 8. MTHFR | |
| Primer set1 C677T wt-lead | 5′tgt ctg cgg gag Ccg att tca tca t |
| | (SEQ ID NO:72) |
| Primer set1 C677T wt-lag | 5′atg atg aaa tcg Gct ccc gca gac a |
| | (SEQ ID NO:73) |
| Primer set1 C677T polymorph- | 5′tgt ctg cgg gag Tcg att tca tca t |
| lead | (SEQ ID NO:74) |
| Primer set1 C677T polymorph lag | 5′atg atg aaa tcg Act ccc gca gac a |
| | (SEQ ID NO:75) |
| Primer set2 A1298C wt-lead | 5′tga cca gtg aag Aaa gtg tct ttg a |
| | (SEQ ID NO:76) |
| Primer set2 A1298C wt-lag | 5′tca aag aca ctt Tct tca ctg gtc a |
| | (SEQ ID NO:77) |
| Primer set2 A1298C polymorph-lead | 5′tga cca gtg aag Caa gtg tct ttg a |
| | (SEQ ID NO:78) |
| Primer set2 A1298C polymorph-lag | 5′tca aag aca ctt Gct tca ctg gtc a |
| | (SEQ ID NO:79) |
| 9. ALDH2 | |
| Primer set1 wt-lead | 5′cag gca tac act Gaa gtg aaa act g |
| | (SEQ ID NO:80) |
| Primer set1 wt-lag | 5′cag ttt tca ctt Cag tgt atg cct g |
| | (SEQ ID NO:81) |
| Primer set1 polymorph-lead | 5′cag gca tac act Aaa gtg aaa act g |
| | (SEQ ID NO:82) |
| Primer set1 polymorph-lag | 5′cag ttt tca ctt Tag tgt atg cct g |
| | (SEQ ID NO:83) |
| 10. beta-Actin | |
| Primer set1 lead | 5′tgc atc tct gcc tta cag atc atg t |
| | (SEQ ID NO:84) |
| Primer set1-lag | 5′aga tga tct gta agg cag aga tgc a |
| | (SEQ ID NO:85) |

TABLE 4

| Allelic Gene | Recommended supplements |
|---|---|
| MTHFR | Riboflavin, niacin, vitamin B6, |
| | folate, vitamin B12, L-serine |
| MnSOD | Zinc, copper, manganese, N-Acetyl-L- |
| | cysteine, lutein, lycopene, Indole- |
| | 3-Carbinol, Bilberry fruit extract, |
| | Alpha-lipoic acid, mixed cartenoids, |
| | taurine. |
| TNF-α | Alpha-lipoic acid, Curcumin root |
| | extract, Cat's claw bark extract, |
| | Green tea leaf extract, Nettle leaf |
| | extract, Magnolia bark extract, |
| | Forskolin, Ginkgo Biloba leaf |
| | extract |
| ENOS | Folate, Curcumin root extract, |
| | Ginkgo Biloba leaf extract, Rosemary |
| | extract, |
| GSTM1, GSTT1, GSTP1 | N-Acetyl-L-cysteine, Silymarin, |
| | Green tea leaf extract, Rosemary |
| | extract, Cruciferous veg |
| | concentrate, Schizandra berry. |
| APOC3 | L-carnitine, Artichoke extract, |
| | Green tea leaf extract, Hawthorne |
| | extract, Garlic extract. |
| VDR bb polymorphism | Vitamin E, Calcium, Indole-3- |
| | Carbinol, Cruciferous veg |
| | concentrate |
| CETP | Taurine, Dandelion root extract, |
| | Curcumin root extract, Glycine, |
| | Artichoke extract, Silymarin |
| IL-6 | Vitamin D, Quercetin dihydrate, N- |
| | Acetyl-L-cysteine, Goldenseal root |
| | extract, Scutellaria baicalensis |
| | root extract, Epimedium |
| | grandiflorum. |
| PPARγ2 | Chromium, Alpha-lipoic acid, Banaba |
| | leaf extract |
| ACE | Magnesium, Taurine, Hawthorne |
| | extract, Andrographis |

TABLE 5

| | Amount per | | % Daily |
|---|---|---|---|
| Servings per container: 90 | serving | | Value* |
| Riboflavin (as riboflavin and | 25-50 | mg | 1471-2941 |
| riboflavin-5-phosphate) | | | |
| Niacin (as niacinamide and niacin) | 50-200 | mg | 250-1000 |
| Vitamin B6 (as pyridoxine HCl and | 25-100 | mg | 1250-5000 |
| pyridoxal-5-phosphate) | | | |
| Folate (as folic acid and Metafolin ™ | 800-1600 | mcg | 200-400 |
| L-methylfolate) | | | |
| Vitamin B12 (as dibencozide) | 100-300 | mcg | 1667-5000 |

TABLE 6

| | Recommended topical treatments - in |
|---|---|
| | addition to nutrient supplements in |
| Allelic Gene | Table 4 |
| Structural: | Retinoic acid, Vitamin C, UV |
| MMP1 | filter, Methylsulfonylmethane, |
| COL1A1 | Dimethylaminoethanol, aloe vera, |
| DCN | ornithine, Ursolic acid, Collagen |
| LOX | Hydrolysate |
| TGFbeta1 | |
| Inflammation: | Calendula triterpenes, aloe vera, |
| ICAM-1 | witch hazel, tea tree oil, |
| TNFα | Trifolium pratense, Euphrasia |
| IL-1B | Extract, evening primrose oil, |
| IL-1A | mulberry extract, soybean protein, |
| IL-4 | astaxanthin, omega-3 fatty acids, |
| IL-6 | Ursolic acid, turmeric |
| IL-10 | |
| Oxidation: | Topical Genistein, n-acetyl |
| SOD1 | cysteine, manganese, zinc, copper, |
| SOD2 | Alpha lipoic acid, vitamin E, |
| CAT | vitamin C, astaxanthin, Green tea |
| PHOX | extract, grape seed extract, |
| LOX | oryzanol, co-enzyme Q10 |
| Detoxification: | Coffee, Green tea extract, Ursolic |
| GSTM1 | acid, squalene, co-enzyme Q10, |
| GSTT1 | Alpha lipoic acid, vitamin E, |
| GSTP1 | vitamin C, n-acetyl cysteine, |
| EPHX1 | Rosemary extract, Silymarin, |
| | Schizandra berry, lavendin oil, |
| | peppermint oil, limonoids (limonin, |
| | nomilin) |
| MTHFR | Topical folate, vitamin B6, vitamin |
| | B12, biotin, riboflavin, Niacin, |
| | Betain HCl |
| eNOS | L-Arginine, ginseng, ornithine |
| hGPX1 | Glutathione, methionine, selenium, |
| | n-acetyl cysteine, |
| | Methylsulfonylmethane |

TABLE 7
DATA SET 1

| | | | | | | | Genetic | |
|---|---|---|---|---|---|---|---|---|
| General | | | | | Links with | Homozygote or | Susceptability | |
| Gene | | | | | higher risks | heterozygote | ranking | |
| Marker | Examples of | Gene | | Links with Cancer | of cancer | relative to wild | Reduces | Normal |
| Type | Gene Types | Marker | Polymorphisms | susceptabilities | susceptibility | type | susceptibility | susceptibility |
| Type 1 | | CYP | | | | | | |
| | Genes that | | Cyp1A1-A | Colorectal, urinary | | Homozygote | | YES |
| | code for | | (Wild-type) | bladder, breast, | | | | |
| | enzymes | | | oral cavity, | | | | |
| | responsible | | | stomach, and lung | | | | |
| | for the | | | cancers | | | | |
| | detoxification of | | | | | | | |
| | xenobiotics in | | | | | | | |
| | Phase I | | | | | | | |
| | metabolism | | | | | | | |
| | | | Cyp1A1-C | Colorectal, urinary | | Homozygote | | |
| | | | | bladder, breast, | | | | |
| | | | | oral cavity, | | | | |
| | | | | stomach, and lung | | | | |
| | | | | cancers. | | | | |
| | | | | | | Heterozygotes | | |
| | | | Ile-Val | Colorectal, urinary | | Homozygote | | |
| | | | polymorphism | bladder, breast, | | | | |
| | | | | oral cavity, | | | | |
| | | | | stomach and lung | | | | |
| | | | | cancers. | | | | |
| | | | | | | Heterozygotes | | |
| | | NAT1 | | | | | | |
| | | | NAT1*4 (wild | | | Homozygote | | YES |
| | | | type) | | | | | |
| | | | NAT1*10 | Colon cancer | | Homozygote | | |

| DATA SET 1 | | | | | |
|---|---|---|---|---|---|
| | Genetic | | | | |
| | Susceptability | | | | |
| General | ranking | | | | |
| Gene | Moderate | | Very | DATA SET 2 | |
| Marker | increase in | Higher | high | Foods and other | |
| Type | susceptibility | susceptibility | susceptibility | materials to avoid | Dietary and lifestyle advice |
| Type 1 | | | | | |
| | | | | Reduce | Consume food products, |
| | | | | consumption of | such as for example |
| | | | | sources of | vegetables and fruit, e.g. |
| | | | | Xenobiotics (e.g. | cruciferous vegetables and |
| | | | | PAH) found in, for | allium family of vegetables. |
| | | | | example, char- | |
| | | | | grilled red meat | |
| | | | | and smoked fish. | |
| | | YES | | Avoid consumption | Increase consumption of food |
| | | | | of sources of | products know to induce |
| | | | | Xenobiotics (e.g. | Phase II metabolism, e.g. |
| | | | | PAH) found in, for | cruciferous and allium family |
| | | | | example, char- | vegetables. |
| | | | | grilled red meat | |
| | | | | and smoked fish. | |
| | YES | | | Avoid consumption | Increase consumption of food |
| | | | | of sources of | products know to induce |
| | | | | Xenobiotics (e.g. | Phase II metabolism, e.g. |
| | | | | PAH) found in, for | cruciferous and allium family |
| | | | | example, char- | vegetables. |
| | | | | grilled red meat | |
| | | | | and smoked fish. | |
| | | YES | | Avoid consumption | Increase consumption of food |
| | | | | of sources of | products know to induce |
| | | | | Xenobiotics (e.g. | Phase II metabolism, e.g. |
| | | | | PAH) found in, for | cruciferous and allium family |
| | | | | example, char- | vegetables. |
| | | | | grilled red meat | |
| | | | | and smoked fish. | |
| | YES | | | Avoid consumption | Increase consumption of food |
| | | | | of sources of | products know to induce |
| | | | | Xenobiotics (e.g. | Phase II metabolism, e.g. |
| | | | | PAH) found in, for | cruciferous and allium family |
| | | | | example, char- | vegetables. |
| | | | | grilled red meat | |
| | | | | and smoked fish. | |
| | | | | Reduce | Consume food products, |
| | | | | consumption of | such as for example |
| | | | | potential | vegetables and fruit, e.g. |
| | | | | procarcinogens | cruciferous and allium family |
| | | | | (e.g. PAH) found | of vegetables. |
| | | | | in, for example, | |
| | | | | char-grilled red | |
| | | | | meat and smoked | |
| | | | | fish. | |
| | | YES | | Avoid consumption | Increase consumption of food |
| | | | | of sources of | products known to induce |
| | | | | Xenobiotics (e.g. | Phase II metabolism, e.g. |
| | | | | PAH) found in, for | increase consumption of fruit |
| | | | | example, char- | and vegetables, particularly |
| | | | | grilled red meat | cruciferous vegetables such |
| | | | | and smoked fish. | as broccoli and members of |
| | | | | | the allium family such as |
| | | | | | garlic and onion. |

TABLE 8
Input Dataset 3 (Alleles Present in Subject's DNA)
\check{ }
Match Each Allele with Lifestyle Risk Factor from Dataset 1
\check{ }
Match Lifestyle Risk Factor with supplement recommendation from
Dataset 2
\check{ }
Cross-reference supplement Recommendation with other Factors (e.g.
sex, existing diet) and amend recommendation as appropriate
\check{ }
Generate supplement recommendation matched to allele and other
factors
\check{ }
Combine supplement recommendations corresponding to each identified
allele
\check{ }
Personalised assessment of supplement requirements

1. A computer assisted method of assessing personalized supplement requirements for a human subject comprising:
(i) providing a first dataset on a data processing means, said first dataset comprising information correlating the presence of individual alleles at genetic loci with a lifestyle risk factor, wherein at least one allele of each genetic locus is known to be associated with increased or decreased disease susceptibility;
(ii) providing a second dataset on a data processing means, said second dataset comprising information matching each said risk factor with at least one supplement
(iii) inputting a third dataset identifying alleles at one or more of the genetic loci of said first dataset of said human subject;
(iv) determining the risk factors associated with said alleles of said human subject using said first dataset;
(v) determining at least one appropriate supplement recommendation based on each identified risk factor from step (iv) using said second dataset; and
(vi) generating a personalized assessment of supplement requirements based on said recommendations.

2. A method according to claim 1 wherein the supplement is a nutrient or therapeutic supplement.

3. A method according to claim 1 wherein the assessment includes recommended minimum and/or maximum amounts of each supplement identified in step (v).

4. A method according to claim 1 comprising producing a report comprising said personalized assessment.

5. A method according to claim 4 comprising the step of delivering the report to the client.

6. A method according to claim 1 wherein said assessment comprises a recipe for a personalised supplement formulation.

7. A method according to claim 6 wherein the supplement formulation comprises said at least one supplement determined in step (v).

8. A method according to claim 7 comprising preparing said personalized supplement formulation.

9. A method according to claim 1 comprising preparing a kit comprising individual preparations of the at least one supplements determined in step (v).

10. A method according to claim 5 wherein the formulation is a nutritional formulation for oral administration or a therapeutic formulation for topical administration.

11. A method according to claim 9 comprising providing and/or delivering the formulation or kit to the individual.

12. A method according to claim 1 wherein said first dataset comprises information relating to two or more alleles of one or more genetic loci of genes selected from the group comprising:
(a) phase I metabolism enzymes responsible for detoxification of xenobiotics,
(b) genes that encode Phase II metabolism enzymes responsible for further detoxification and excretion of xenobiotics,
(c) genes that encode enzymes that combat oxidative stress,
(d) genes associated with micronutrient deficiency,
(e) genes that encode enzymes responsible for metabolism of alcohol,
(f) genes that encode enzymes involved in lipid and/or cholesterol metabolism,
(g) genes that encode enzymes involved in clotting,
(h) genes that encode trypsin inhibitors,
(i) genes that encode enzymes related to susceptibility to metal toxicity,
(j) genes which encode proteins required for normal cellular metabolism and growth,
(k) genes which encoded HLA Class 2 molecules,
(l) genes that encode proteins involved with inflammation processes and,
(m) genes involved in calcium metabolism and bone growth and maintenance.

13. A method according to claim 12 wherein said first dataset comprises information relating to two or more alleles of one or more genetic loci of genes encoding an enzyme selected from the group comprising: cytochrome P450 monooxygenase, N-acetyltransferase 1, N-acetyltransferase 2, glutathione-S-transferase, manganese superoxide dismutase, 5,10-methylenetetrahydrofolatereductase and alcohol dehydrogenase 2.

14. A method according to claim 12 wherein said first dataset comprises information relating to two or more alleles of the genetic loci of genes encoding the enzymes: 5,10-methylenetetrahydrofolate reductase (MTHFR), methionine synthase (MTR), methionine synthase reductase (MTRR), cystathione beta synthase (CBS), vitamin D receptor (VDR), collagen type I alpha (COL1A1), interleukin 6 (IL-6), tumour necrosis factor alpha (TNFα), angiotensin converting enzyme (ACE), peroxisome proliferators activated receptor (PPAR-gamma 2), manganese superoxide dismutase (SOD2), extracellular superoxide dismutase (SOD3), glutathione S-transferase M1 (GSTM1), glutathione S-transferase theta1 (GSTT1), glutathione S-transferase pi (GSTP1), apolipoprotein C-III (APOC3), cholesteryl ester transfer protein (CETP), lipoprotein lipase (LPL), endothelial nitric oxide synthase (eNOS), factor 5 (F5) and apolipoprotein E (ApoE4).

15. A method according to claim 1 comprising the step of determining the presence of individual alleles at one or more genetic loci of the DNA in a DNA sample of said human subject, and constructing the dataset used in step (iii) using results of said determination.

16. A method according to claim 15 wherein said presence of said individual alleles is determined by hybridisation with allele-specific oligonucleotides.

17. A method according to claim 16 wherein said allele specific oligonucleotides are selected from oligonucleotides each specific for one of the genes selected from the group comprising the CYP1A1 gene, the GSTμ. gene, the GSTπ gene, the GSTθ gene, the NAT1 gene, the NAT2 gene, the MnSOD gene, the MTHFR gene and the ALDH2 gene.

18. A method according to claim 1 comprising the additional steps;
(vii) providing a fourth dataset on a data processing means, said fourth dataset comprising information matching each said risk factor with at least one lifestyle recommendation;
(viii) determining at least one appropriate lifestyle recommendation based on each identified risk factor from step (iv) using said fourth dataset; and
(viii) generating a personalized lifestyle advice plan based on said lifestyle recommendations.

19. A method according to claim 18 comprising producing a report comprising said personalized lifestyle advice plan and said personalized assessment of supplement requirements.


SEQUENCE LISTING (205 sequences)

SEQ ID NO: 1 - DNA, 25 bp, Artificial Sequence
  Description of Artificial Sequence Oligonucleotide
atcggtgagaccattgcccgctggg

SEQ ID NO: 2 - DNA, 25 bp, Artificial Sequence
  Description of Artificial Sequence Oligonucleotide
cccagcgggcaatggtctcaccgat

SEQ ID NO: 3 - DNA, 25 bp, Artificial Sequence
  Description of Artificial Sequence Oligonucleotide
atcggtgagaccgttgcccgctggg

SEQ ID NO: 4 - DNA, 25 bp, Artificial Sequence
  Description of Artificial Sequence Oligonucleotide
cccagcgggcaacggtctcaccgat

SEQ ID NO: 5 - DNA, 25 bp, Artificial Sequence
  Description of Artificial Sequence Oligonucleotide
acctccacctcctgggctcacacga

SEQ ID NO: 6 - DNA, 25 bp, Artificial Sequence
  Description of Artificial Sequence Oligonucleotide
tcgtgtgagcccaggaggtggaggt

SEQ ID NO: 7 - DNA, 25 bp, Artificial Sequence
  Description of Artificial Sequence Oligonucleotide
acctccacctcccgggctcacacga

SEQ ID NO: 8 - DNA, 25 bp, Artificial Sequence
  Description of Artificial Sequence Oligonucleotide
tcgtgtgagcccgggaggtggaggt

SEQ ID NO: 9 - DNA, 25 bp, Artificial Sequence
  Description of Artificial Sequence Oligonucleotide
caggtgccttgtgtcttccgtttga

SEQ ID NO: 10 - DNA, 25 bp, Artificial Sequence
  Description of Artificial Sequence Oligonucleotide
tcaaacggaagacacaaggcacctg

SEQ ID NO: 11 - DNA, 25 bp, Artificial Sequence
  Description of Artificial Sequence Oligonucleotide
caggtgccttgtatcttccgtttga

SEQ ID NO: 12 - DNA, 25 bp, Artificial Sequence
  Description of Artificial Sequence Oligonucleotide
tcaaacggaagatacaaggcacctg

SEQ ID NO: 13 - DNA, 25 bp, Artificial Sequence
  Description of Artificial Sequence Oligonucleotide
cttccgtttgacggaagagaatgga

SEQ ID NO: 14 - DNA, 25 bp, Artificial Sequence
  Description of Artificial Sequence Oligonucleotide
tccattctcttccgtcaaacggaag

SEQ ID NO: 15 - DNA, 25 bp, Artificial Sequence
  Description of Artificial Sequence Oligonucleotide
cttccgtttgacagaagagaatgga

SEQ ID NO: 16 - DNA, 25 bp, Artificial Sequence
  Description of Artificial Sequence Oligonucleotide
tccattctcttctgtcaaacggaag

SEQ ID NO: 17 - DNA, 25 bp, Artificial Sequence
  Description of Artificial Sequence Oligonucleotide
acagcaaataccgaaaaatctactc

SEQ ID NO: 18 - DNA, 25 bp, Artificial Sequence
  Description of Artificial Sequence Oligonucleotide
gagtagatttttcggtatttgctgt

SEQ ID NO: 19 - DNA, 25 bp, Artificial Sequence
  Description of Artificial Sequence Oligonucleotide
acagcaaataccaaaaaatctactc

SEQ ID NO: 20 - DNA, 25 bp, Artificial Sequence
  Description of Artificial Sequence Oligonucleotide
gagtagattttttcctatttgctgt

SEQ ID NO: 21 - DNA, 25 bp, Artificial Sequence
  Description of Artificial Sequence Oligonucleotide
taataataataataaatgtctttta

SEQ ID NO: 22 - DNA, 25 bp, Artificial Sequence
  Description of Artificial Sequence Oligonucleotide
taaaagacatttattattattatta

SEQ ID NO: 23 - DNA, 25 bp, Artificial Sequence
  Description of Artificial Sequence Oligonucleotide
taataataataataaatgtatttta

SEQ ID NO: 24 - DNA, 25 bp, Artificial Sequence
  Description of Artificial Sequence Oligonucleotide
taaaatacatttattattttaatta

SEQ ID NO: 25 - DNA, 25 bp, Artificial Sequence
  Description of Artificial Sequence Oligonucleotide
taataataataaaaaatgtctttta

SEQ ID NO: 26 - DNA, 25 bp, Artificial Sequence
  Description of Artificial Sequence Oligonucleotide
taaaagacattttttattttaatta

SEQ ID NO: 27 - DNA, 25 bp, Artificial Sequence
  Description of Artificial Sequence Oligonucleotide
taaaatacattttttattttaatta

SEQ ID NO: 28 - DNA, 25 bp, Artificial Sequence
  Description of Artificial Sequence Oligonucleotide
aataataaatgtcttttaaagatgg

SEQ ID NO: 29 - DNA, 25 bp, Artificial Sequence
  Description of Artificial Sequence Oligonucleotide
ccatctttaaaagacatttattatt

SEQ ID NO: 30 - DNA, 25 bp, Artificial Sequence
  Description of Artificial Sequence Oligonucleotide
aataaaaaatgtcttttaaagatgg

SEQ ID NO: 31 - DNA, 25 bp, Artificial Sequence
  Description of Artificial Sequence Oligonucleotide
ccatctttaaaagacattttttatt

SEQ ID NO: 32 - DNA, 25 bp, Artificial Sequence
  Description of Artificial Sequence Oligonucleotide
aataataaatgtattttaaagatgg

SEQ ID NO: 33 - DNA, 25 bp, Artificial Sequence
  Description of Artificial Sequence Oligonucleotide
ccatctttaaaatacatttattatt

SEQ ID NO: 34 - DNA, 25 bp, Artificial Sequence
  Description of Artificial Sequence Oligonucleotide
aataaaaaatgtattttaaagatgg

SEQ ID NO: 35 - DNA, 25 bp, Artificial Sequence
  Description of Artificial Sequence Oligonucleotide
ccatctttaaaatacattttttatt

SEQ ID NO: 36 - DNA, 25 bp, Artificial Sequence
  Description of Artificial Sequence Oligonucleotide
agggtatttttacatccctccagtt

SEQ ID NO: 37 - DNA, 25 bp, Artificial Sequence
  Description of Artificial Sequence Oligonucleotide
aactggagggatgtaaaaataccct

SEQ ID NO: 38 - DNA, 25 bp, Artificial Sequence
  Description of Artificial Sequence Oligonucleotide
agggtatttttatatccctccagtt

SEQ ID NO: 39 - DNA, 25 bp, Artificial Sequence
  Description of Artificial Sequence Oligonucleotide
aactggagggatataaaaataccct

SEQ ID NO: 40 - DNA, 25 bp, Artificial Sequence
  Description of Artificial Sequence Oligonucleotide
ggaatctggtacctggaccaaatca

SEQ ID NO: 41 - DNA, 25 bp, Artificial Sequence
  Description of Artificial Sequence Oligonucleotide
tgatttggtccaggtaccagattcc

SEQ ID NO: 42 - DNA, 25 bp, Artificial Sequence
  Description of Artificial Sequence Oligonucleotide
ggaatctggtacttggaccaaatca

SEQ ID NO: 43 - DNA, 25 bp, Artificial Sequence
  Description of Artificial Sequence Oligonucleotide
tgatttggtccaagtaccagattcc

SEQ ID NO: 44 - DNA, 25 bp, Artificial Sequence
  Description of Artificial Sequence Oligonucleotide
cgcttgaacctcgaacaattgaaga

SEQ ID NO: 45 - DNA, 25 bp, Artificial Sequence
  Description of Artificial Sequence Oligonucleotide
tcttcaattgttcgaggttcaagcg

SEQ ID NO: 46 - DNA, 25 bp, Artificial Sequence
  Description of Artificial Sequence Oligonucleotide
cgcttgaacctcaaacaattgaaga

SEQ ID NO: 47 - DNA, 25 bp, Artificial Sequence
  Description of Artificial Sequence Oligonucleotide
tcttcaattgtttgaggttcaagcg

SEQ ID NO: 48 - DNA, 25 bp, Artificial Sequence
  Description of Artificial Sequence Oligonucleotide
aacctggtgatggatcccttactat

SEQ ID NO: 49 - DNA, 25 bp, Artificial Sequence
  Description of Artificial Sequence Oligonucleotide
atagtaagggatccatcaccaggtt

SEQ ID NO: 50 - DNA, 25 bp, Artificial Sequence
  Description of Artificial Sequence Oligonucleotide
aacctggtgatgaatcccttactat

SEQ ID NO: 51 - DNA, 25 bp, Artificial Sequence
  Description of Artificial Sequence Oligonucleotide
atagtaagggattcatcaccaggtt

SEQ ID NO: 52 - DNA, 25 bp, Artificial Sequence
  Description of Artificial Sequence Oligonucleotide
gctacattgcccgcaagcacaacct

SEQ ID NO: 53 - DNA, 25 bp, Artificial Sequence
  Description of Artificial Sequence Oligonucleotide
aggttgtgcttgcgggcaatgtagc

SEQ ID NO: 54 - DNA, 25 bp, Artificial Sequence
  Description of Artificial Sequence Oligonucleotide
cgctgcaaatacatctccctcatct

SEQ ID NO: 55 - DNA, 25 bp, Artificial Sequence
  Description of Artificial Sequence Oligonucleotide
agatgagggagatgtatttgcagcg

SEQ ID NO: 56 - DNA, 25 bp, Artificial Sequence
  Description of Artificial Sequence Oligonucleotide
cgctgcaaatacgtctccctcatct

SEQ ID NO: 57 - DNA, 25 bp, Artificial Sequence
  Description of Artificial Sequence Oligonucleotide
agatgagggagacgtatttgcagcg

SEQ ID NO: 58 - DNA, 25 bp, Artificial Sequence
  Description of Artificial Sequence Oligonucleotide
tctggcaggaggcgggcaaggatga

SEQ ID NO: 59 - DNA, 25 bp, Artificial Sequence
  Description of Artificial Sequence Oligonucleotide
tcatccttgcccgcctcctgccaga

SEQ ID NO: 60 - DNA, 25 bp, Artificial Sequence
  Description of Artificial Sequence Oligonucleotide
tctggcaggaggtgggcaaggatga

SEQ ID NO: 61 - DNA, 25 bp, Artificial Sequence
  Description of Artificial Sequence Oligonucleotide
tcatccttgcccacctcctgccaga

SEQ ID NO: 62 - DNA, 25 bp, Artificial Sequence
  Description of Artificial Sequence Oligonucleotide
accataaagcagaagctgatgccct

SEQ ID NO: 63 - DNA, 25 bp, Artificial Sequence
  Description of Artificial Sequence Oligonucleotide
agggcatcagcttctgctttatggt

SEQ ID NO: 64 - DNA, 25 bp, Artificial Sequence
  Description of Artificial Sequence Oligonucleotide
agctggctccggttttggggtatct

SEQ ID NO: 65 - DNA, 25 bp, Artificial Sequence
  Description of Artificial Sequence Oligonucleotide
agataccccaaaaccggagccagct

SEQ ID NO: 66 - DNA, 25 bp, Artificial Sequence
  Description of Artificial Sequence Oligonucleotide
agctggctccggctttggggtatct

SEQ ID NO: 67 - DNA, 25 bp, Artificial Sequence
  Description of Artificial Sequence Oligonucleotide
agataccccaaagccggagccagct

SEQ ID NO: 68 - DNA, 25 bp, Artificial Sequence
  Description of Artificial Sequence Oligonucleotide
ttacagcccagatagctcttcagcc

SEQ ID NO: 69 - DNA, 25 bp, Artificial Sequence
  Description of Artificial Sequence Oligonucleotide
ggctgaagagctatctgggctgtaa

SEQ ID NO: 70 - DNA, 25 bp, Artificial Sequence
  Description of Artificial Sequence Oligonucleotide
ttacagcccagacagctcttcagcc

SEQ ID NO: 71 - DNA, 25 bp, Artificial Sequence
  Description of Artificial Sequence Oligonucleotide
ggctgaagagctgtctgggctgtaa

SEQ ID NO: 72 - DNA, 25 bp, Artificial Sequence
  Description of Artificial Sequence Oligonucleotide
tgtctgcgggagccgatttcatcat

SEQ ID NO: 73 - DNA, 25 bp, Artificial Sequence
  Description of Artificial Sequence Oligonucleotide
atgatgaaatcggctcccgcagaca

SEQ ID NO: 74 - DNA, 25 bp, Artificial Sequence
  Description of Artificial Sequence Oligonucleotide
tgtctgcgggagtcgatttcatcat

SEQ ID NO: 75 - DNA, 25 bp, Artificial Sequence
  Description of Artificial Sequence Oligonucleotide
atgatgaaatcgactcccgcagaca

SEQ ID NO: 76 - DNA, 25 bp, Artificial Sequence
  Description of Artificial Sequence Oligonucleotide
tgaccagtgaagaaagtgtctttga

SEQ ID NO: 77 - DNA, 25 bp, Artificial Sequence
  Description of Artificial Sequence Oligonucleotide
tcaaagacactttcttcactggtca

SEQ ID NO: 78 - DNA, 25 bp, Artificial Sequence
  Description of Artificial Sequence Oligonucleotide
tgaccagtgaagcaagtgtctttga

SEQ ID NO: 79 - DNA, 25 bp, Artificial Sequence
  Description of Artificial Sequence Oligonucleotide
tcaaagacacttgcttcactggtca

SEQ ID NO: 80 - DNA, 25 bp, Artificial Sequence
  Description of Artificial Sequence Oligonucleotide
caggcatacactgaagtgaaaactg

SEQ ID NO: 81 - DNA, 25 bp, Artificial Sequence
  Description of Artificial Sequence Oligonucleotide
cagttttcacttcagtgtatgcctg

SEQ ID NO: 82 - DNA, 25 bp, Artificial Sequence
  Description of Artificial Sequence Oligonucleotide
caggcatacactaaagtgaaaactg

SEQ ID NO: 83 - DNA, 25 bp, Artificial Sequence
  Description of Artificial Sequence Oligonucleotide
cagttttcactttagtgtatgcctg

SEQ ID NO: 84 - DNA, 25 bp, Artificial Sequence
  Description of Artificial Sequence Oligonucleotide
tgcatctctgccttacagatcatgt

SEQ ID NO: 85 - DNA, 25 bp, Artificial Sequence
  Description of Artificial Sequence Oligonucleotide
agatgatctgtaaggcagagatgca

SEQ ID NO: 86 - DNA, 19 bp, Artificial Sequence
  Description of Artificial Sequence Primer
gggtttggacgctcatacc

SEQ ID NO: 87 - DNA, 25 bp, Artificial Sequence
  Description of Artificial Sequence Primer
aatgtactgttcccttctgatttgg

SEQ ID NO: 88 - DNA, 20 bp, Artificial Sequence
  Description of Artificial Sequence Primer
tccgtttgacggaagagaat

SEQ ID NO: 89 - DNA, 20 bp, Artificial Sequence
  Description of Artificial Sequence Primer
gggtctgcaaggaacaaaat

SEQ ID NO: 90 - DNA, 18 bp, Artificial Sequence
  Description of Artificial Sequence Primer
gaaacataaccacaaacc

SEQ ID NO: 91 - DNA, 24 bp, Artificial Sequence
  Description of Artificial Sequence Primer
caacaataaaccaacattaaaagc

SEQ ID NO: 92 - DNA, 22 bp, Artificial Sequence
  Description of Artificial Sequence Primer
acttctgtactgggctctgacc

SEQ ID NO: 93 - DNA, 22 bp, Artificial Sequence
  Description of Artificial Sequence Primer
gcatcgacaatgtaattcctgc

SEQ ID NO: 94 - DNA, 18 bp, Artificial Sequence
  Description of Artificial Sequence Primer
aatacagcactggcatgg

SEQ ID NO: 95 - DNA, 20 bp, Artificial Sequence
  Description of Artificial Sequence Primer
caaggaacaaaatgatgtgg

SEQ ID NO: 96 - DNA, 20 bp, Artificial Sequence
  Description of Artificial Sequence Primer
gtgggcttcatcctcaccta

SEQ ID NO: 97 - DNA, 23 bp, Artificial Sequence
  Description of Artificial Sequence Primer
gggtgatacatacacaagggttt

SEQ ID NO: 98 - DNA, 18 bp, Artificial Sequence
  Description of Artificial Sequence Primer
cagcccacacattcttgg

SEQ ID NO: 99 - DNA, 18 bp, Artificial Sequence
  Description of Artificial Sequence Primer
aagcgggagatgaagtcc

SEQ ID NO: 100 - DNA, 20 bp, Artificial Sequence
  Description of Artificial Sequence Primer
aggttaccccaaaggccacc

SEQ ID NO: 101 - DNA, 19 bp, Artificial Sequence
  Description of Artificial Sequence Primer
gcaagtgatgcccatgtcg

SEQ ID NO: 102 - DNA, 23 bp, Artificial Sequence
  Description of Artificial Sequence Primer
tcttctacctgaagagcaagtcc

SEQ ID NO: 103 - DNA, 22 bp, Artificial Sequence
  Description of Artificial Sequence Primer
caagtcactttgtgaccattcc

SEQ ID NO: 104 - DNA, 19 bp, Artificial Sequence
  Description of Artificial Sequence Primer
cctgaactgccacttcagc

SEQ ID NO: 105 - DNA, 20 bp, Artificial Sequence
  Description of Artificial Sequence Primer
ccaggaagagaaagacctcc

SEQ ID NO: 106 - DNA, 22 bp, Artificial Sequence
  Description of Artificial Sequence Primer
cccattctgtgtttgggttttt

SEQ ID NO: 107 - DNA, 20 bp, Artificial Sequence
  Description of Artificial Sequence Primer
agaggctgaggtgggagaat

SEQ ID NO: 108 - DNA, 22 bp, Artificial Sequence
  Description of Artificial Sequence Primer
gaggtcattctgaaggccaagg

SEQ ID NO: 109 - DNA, 20 bp, Artificial Sequence
  Description of Artificial Sequence Primer
tttgtggactgctgaggacg

SEQ ID NO: 110 - DNA, 18 bp, Artificial Sequence
  Description of Artificial Sequence Primer
tcctcagatcattgctcc

SEQ ID NO: 111 - DNA, 22 bp, Artificial Sequence
  Description of Artificial Sequence Primer
taacgcaactaagtcatagtcc

SEQ ID NO: 112 - DNA, 20 bp, Artificial Sequence
  Description of Artificial Sequence Primer
ggctgtgctttctcgtcttc

SEQ ID NO: 113 - DNA, 20 bp, Artificial Sequence
  Description of Artificial Sequence Primer
ggtgacgttcaggttgttca

SEQ ID NO: 114 - DNA, 20 bp, Artificial Sequence
  Description of Artificial Sequence Primer
acagtggttgaaaaagtagg

SEQ ID NO: 115 - DNA, 20 bp, Artificial Sequence
  Description of Artificial Sequence Primer
caaaatgtagataagggtgc

SEQ ID NO: 116 - DNA, 20 bp, Artificial Sequence
  Description of Artificial Sequence Primer
ttggtggctacaagatgtcg

SEQ ID NO: 117 - DNA, 20 bp, Artificial Sequence
  Description of Artificial Sequence Primer
aggtcctgaacttccagcag

SEQ ID NO: 118 - DNA, 20 bp, Artificial Sequence
  Description of Artificial Sequence Primer
gctctatgggaaggaccagc

SEQ ID NO: 119 - DNA, 20 bp, Artificial Sequence
  Description of Artificial Sequence Primer
aagccacctgaggggtaagg

SEQ ID NO: 120 - DNA, 18 bp, Artificial Sequence
  Description of Artificial Sequence Primer
cagcagggtctcaaaagg

SEQ ID NO: 121 - DNA, 18 bp, Artificial Sequence
  Description of Artificial Sequence Primer
gatggacaggcagaatgg

SEQ ID NO: 122 - DNA, 18 bp, Artificial Sequence
  Description of Artificial Sequence Primer
catgggcaagcggaagtg

SEQ ID NO: 123 - DNA, 24 bp, Artificial Sequence
  Description of Artificial Sequence Primer
caggatagccaggaagagaaagac

SEQ ID NO: 124 - DNA, 20 bp, Artificial Sequence
  Description of Artificial Sequence Primer
agacagggtccccaggtcat

SEQ ID NO: 125 - DNA, 20 bp, Artificial Sequence
  Description of Artificial Sequence Primer
cagaggctgaggtgggagaa

SEQ ID NO: 126 - DNA, 25 bp, Artificial Sequence
  Description of Artificial Sequence Primer
ggagttaatttctgggaaggatcag

SEQ ID NO: 127 - DNA, 28 bp, Artificial Sequence
  Description of Artificial Sequence Primer
tggtctagataccagaatccattctctt

SEQ ID NO: 128 - DNA, 23 bp, Artificial Sequence
  Description of Artificial Sequence Primer
ggcagcctctggagttaatttct

SEQ ID NO: 129 - DNA, 26 bp, Artificial Sequence
  Description of Artificial Sequence Primer
ttcccttctgatttggtctagatacc

SEQ ID NO: 130 - DNA, 25 bp, Artificial Sequence
  Description of Artificial Sequence Primer
gggaacagtacattccaaatgaaga

SEQ ID NO: 131 - DNA, 26 bp, Artificial Sequence
  Description of Artificial Sequence Primer
tgttcgaggcttaagagtaaaggagt

SEQ ID NO: 132 - DNA, 31 bp, Artificial Sequence
  Description of Artificial Sequence Primer
aacaattgaagattttgagtctatgaataca

SEQ ID NO: 133 - DNA, 28 bp, Artificial Sequence
  Description of Artificial Sequence Primer
tctgcaaggaacaaaatgatttactagt

SEQ ID NO: 134 - DNA, 26 bp, Artificial Sequence
  Description of Artificial Sequence Primer
gaaacataaccacaaaccttttcaaa

SEQ ID NO: 135 - DNA, 25 bp, Artificial Sequence
  Description of Artificial Sequence Primer
aaatcaccaatttccaagataacca

SEQ ID NO: 136 - DNA, 29 bp, Artificial Sequence
  Description of Artificial Sequence Primer
aaacataaccacaaaccttttcaaataat

SEQ ID NO: 137 - DNA, 25 bp, Artificial Sequence
  Description of Artificial Sequence Primer
aaatcaccaatttccaagataacca

SEQ ID NO: 138 - DNA, 25 bp, Artificial Sequence
  Description of Artificial Sequence Primer
aatcaacttctgtactgggctctga

SEQ ID NO: 139 - DNA, 22 bp, Artificial Sequence
  Description of Artificial Sequence Primer
ccatgccagtgctgtatttgtt

SEQ ID NO: 140 - DNA, 23 bp, Artificial Sequence
  Description of Artificial Sequence Primer
tgcattttctgcttgacagaaga

SEQ ID NO: 141 - DNA, 30 bp, Artificial Sequence
  Description of Artificial Sequence Primer
tttgtttgtaatatactgctctctcctgat

SEQ ID NO: 142 - DNA, 24 bp, Artificial Sequence
  Description of Artificial Sequence Primer
gccaaagaagaaacaccaaaaaat

SEQ ID NO: 143 - DNA, 29 bp, Artificial Sequence
  Description of Artificial Sequence Primer
aaatgatgtggttataaatgaagatgttg

SEQ ID NO: 144 - DNA, 28 bp, Artificial Sequence
  Description of Artificial Sequence Primer
aagaggttgaagaagtgctgaaaaatat

SEQ ID NO: 145 - DNA, 29 bp, Artificial Sequence
  Description of Artificial Sequence Primer
atacatacacaagggtttattttgttcct

SEQ ID NO: 146 - DNA, 21 bp, Artificial Sequence
  Description of Artificial Sequence Primer
gttccagcccacacattcttg

SEQ ID NO: 147 - DNA, 23 bp, Artificial Sequence
  Description of Artificial Sequence Primer
cgggagatgaagtccttcagatt

SEQ ID NO: 148 - DNA, 20 bp, Artificial Sequence
  Description of Artificial Sequence Primer
cctggtggacatggtgaatg

SEQ ID NO: 149 - DNA, 25 bp, Artificial Sequence
  Description of Artificial Sequence Primer
gcagatgctcacatagttggtgtag

SEQ ID NO: 150 - DNA, 26 bp, Artificial Sequence
  Description of Artificial Sequence Primer
gggatgagagtaggatgatacatggt

SEQ ID NO: 151 - DNA, 22 bp, Artificial Sequence
  Description of Artificial Sequence Primer
gggtctcaaaaggcttcagttg

SEQ ID NO: 152 - DNA, 22 bp, Artificial Sequence
  Description of Artificial Sequence Primer
tcattctgaaggccaaggactt

SEQ ID NO: 153 - DNA, 20 bp, Artificial Sequence
  Description of Artificial Sequence Primer
cagggcatcagcttctgctt

SEQ ID NO: 154 - DNA, 21 bp, Artificial Sequence
  Description of Artificial Sequence Primer
ggctgtgctttctcgtcttca

SEQ ID NO: 155 - DNA, 19 bp, Artificial Sequence
  Description of Artificial Sequence Primer
ttctgcctggagcccagat

SEQ ID NO: 156 - DNA, 26 bp, Artificial Sequence
  Description of Artificial Sequence Primer
gtgttgcatttacttcaggagatgtt

SEQ ID NO: 157 - DNA, 27 bp, Artificial Sequence
  Description of Artificial Sequence Primer
tccagaaaatgctatgattgatatgac

SEQ ID NO: 158 - DNA, 23 bp, Artificial Sequence
  Description of Artificial Sequence Primer
gacctgaagcacttgaaggagaa

SEQ ID NO: 159 - DNA, 22 bp, Artificial Sequence
  Description of Artificial Sequence Primer
tcaaagaaaagctgcgtgatga

SEQ ID NO: 160 - DNA, 20 bp, Artificial Sequence
  Description of Artificial Sequence Primer
aagagcaagtcccccaagga

SEQ ID NO: 161 - DNA, 21 bp, Artificial Sequence
  Description of Artificial Sequence Primer
ctttgtgaccattccggtttg

SEQ ID NO: 162 - DNA, 22 bp, Artificial Sequence
  Description of Artificial Sequence Primer
ccctttggtggctacaagatgt

SEQ ID NO: 163 - DNA, 19 bp, Artificial Sequence
  Description of Artificial Sequence Primer
agaccctcaagccccaaca

SEQ ID NO: 164 - DNA, 14 bp, Artificial Sequence
  Description of Artificial Sequence Probe
cggtgagaccattg

SEQ ID NO: 165 - DNA, 14 bp, Artificial Sequence
  Description of Artificial Sequence Probe
cggtgagaccgttg

SEQ ID NO: 166 - DNA, 14 bp, Artificial Sequence
  Description of Artificial Sequence Probe
ctccacctcctggg

SEQ ID NO: 167 - DNA, 14 bp, Artificial Sequence
  Description of Artificial Sequence Probe
ctccacctcccggg

SEQ ID NO: 168 - DNA, 13 bp, Artificial Sequence
  Description of Artificial Sequence Probe
gccttgtgtcttc

SEQ ID NO: 169 - DNA, 14 bp, Artificial Sequence
  Description of Artificial Sequence Probe
tgccttgtatcttc

SEQ ID NO: 170 - DNA, 15 bp, Artificial Sequence
  Description of Artificial Sequence Probe
cgtttgacggaagag

SEQ ID NO: 171 - DNA, 15 bp, Artificial Sequence
  Description of Artificial Sequence Probe
cgtttgacagaagag

SEQ ID NO: 172 - DNA, 14 bp, Artificial Sequence
  Description of Artificial Sequence Probe
aataccgaaaaatc

SEQ ID NO: 173 - DNA, 15 bp, Artificial Sequence
  Description of Artificial Sequence Probe
caaataccaaaaaat

SEQ ID NO: 174 - DNA, 15 bp, Artificial Sequence
  Description of Artificial Sequence Probe
catctccatcatctg

SEQ ID NO: 175 - DNA, 15 bp, Artificial Sequence
  Description of Artificial Sequence Probe
acatctccagcatct

SEQ ID NO: 176 - DNA, 18 bp, Artificial Sequence
  Description of Artificial Sequence Probe
gccatctttaaaagacat

SEQ ID NO: 177 - DNA, 19 bp, Artificial Sequence
  Description of Artificial Sequence Probe
gccatctttaaaatacatt

SEQ ID NO: 178 - DNA, 19 bp, Artificial Sequence
  Description of Artificial Sequence Probe
agggtatttttacatccct

SEQ ID NO: 179 - DNA, 20 bp, Artificial Sequence
  Description of Artificial Sequence Probe
agggtatttttatatccctc

SEQ ID NO: 180 - DNA, 17 bp, Artificial Sequence
  Description of Artificial Sequence Probe
tctggtacctggaccaa

SEQ ID NO: 181 - DNA, 19 bp, Artificial Sequence
  Description of Artificial Sequence Probe
aatctggtacttggaccaa

SEQ ID NO: 182 - DNA, 15 bp, Artificial Sequence
  Description of Artificial Sequence Probe
tgaacctcgaacaat

SEQ ID NO: 183 - DNA, 17 bp, Artificial Sequence
  Description of Artificial Sequence Probe
ttgaacctcaaacaatt

SEQ ID NO: 184 - DNA, 14 bp, Artificial Sequence
  Description of Artificial Sequence Probe
ctggtgatggatcc

SEQ ID NO: 185 - DNA, 14 bp, Artificial Sequence
  Description of Artificial Sequence Probe
ctggtgatgaatcc

SEQ ID NO: 186 - DNA, 13 bp, Artificial Sequence
  Description of Artificial Sequence Probe
caagcagttgggc

SEQ ID NO: 187 - DNA, 13 bp, Artificial Sequence
  Description of Artificial Sequence Probe
caagcacttgggc

SEQ ID NO: 188 - DNA, 16 bp, Artificial Sequence
  Description of Artificial Sequence Probe
gcaaatacatctccct

SEQ ID NO: 189 - DNA, 16 bp, Artificial Sequence
  Description of Artificial Sequence Probe
gcaaatacgtctccct

SEQ ID NO: 190 - DNA, 13 bp, Artificial Sequence
  Description of Artificial Sequence Probe
ccttgcccgcctc

SEQ ID NO: 191 - DNA, 13 bp, Artificial Sequence
  Description of Artificial Sequence Probe
cttgcccacctcc

SEQ ID NO: 192 - DNA, 12 bp, Artificial Sequence
  Description of Artificial Sequence Probe
cctgcagacccc

SEQ ID NO: 193 - DNA, 14 bp, Artificial Sequence
  Description of Artificial Sequence Probe
accccaaaaccgga

SEQ ID NO: 194 - DNA, 14 bp, Artificial Sequence
  Description of Artificial Sequence Probe
accccaaagccgga

SEQ ID NO: 195 - DNA, 13 bp, Artificial Sequence
  Description of Artificial Sequence Probe
agcccagatagct

SEQ ID NO: 196 - DNA, 13 bp, Artificial Sequence
  Description of Artificial Sequence Probe
agcccagacagct

SEQ ID NO: 197 - DNA, 14 bp, Artificial Sequence
  Description of Artificial Sequence Probe
aaatcggctcccgc

SEQ ID NO: 198 - DNA, 17 bp, Artificial Sequence
  Description of Artificial Sequence Probe
aaatcgactcccgcaga

SEQ ID NO: 199 - DNA, 16 bp, Artificial Sequence
  Description of Artificial Sequence Probe
cagtgaagaaagtgtc

SEQ ID NO: 200 - DNA, 15 bp, Artificial Sequence
  Description of Artificial Sequence Probe
agtgaagcaagtgtc

SEQ ID NO: 201 - DNA, 21 bp, Artificial Sequence
  Description of Artificial Sequence Probe
tcacagttttcacttcagtgt

SEQ ID NO: 202 - DNA, 21 bp, Artificial Sequence
  Description of Artificial Sequence Probe
tcacagttttcactttagtgt

SEQ ID NO: 203 - DNA, 23 bp, Artificial Sequence
  Description of Artificial Sequence Probe
ccatctttaaaatacatttatta

SEQ ID NO: 204 - DNA, 22 bp, Artificial Sequence
  Description of Artificial Sequence Probe
catctttaaaatacatttttta

SEQ ID NO: 205 - DNA, 25 bp, Artificial Sequence
  Description of Artificial Sequence Oligonucleotide
taataataataaaaaatgtatttta